(19) United States
(12) Patent Application Publication
(10) Pub. No.: US 2025/0381687 A1
(43) Pub. Date: Dec. 18, 2025

(54) CUTTING DEVICE

(71) Applicant: Panasonic Intellectual Property Management Co., Ltd., Osaka (JP)

(72) Inventors: YOSHIHIRO OKADA, Osaka (JP); HITOSHI OGAWA, Shiga (JP)

(21) Appl. No.: 19/224,952

(22) Filed: Jun. 2, 2025

(30) Foreign Application Priority Data
Jun. 12, 2024 (JP) 2024-095394

(51) Int. Cl. B26B 19/38; B26B 19/06; B26B 19/28

(52) U.S. Cl. CPC B26B 19/3846; B26B 19/063; B26B 19/28

(57) ABSTRACT

The present disclosure provides a cutting device that allows the operability thereof to be further improved. The cutting device according to the present disclosure includes a main body a blade part attached to one end of the main body in a first direction. The main body includes a first main body portion elongated in the first direction. The blade part is attached to one end of the first main body in the first direction. Further, at least one of the following requirement (A) or (B) is satisfied: (A) (i) the main body comprises a second main body portion configured to be connected to the other end of the first main body portion in the first direction, (ii) the second main body portion is connected to the first main body portion via a coupling portion, and (iii) the coupling portion includes a pivot shaft configured to rotate the second main body portion relative to the first main body portion, or (B) the main body comprises a second main body portion connected to the other end of the first main body portion in the first direction in a state where the second main body portion is elongated in a second direction which intersects the first direction.

### TECHNICAL FIELD

The present disclosure relates to a cutting device.

### BACKGROUND

Conventionally, as a cutting device, as disclosed in Patent Literature 1, a hair clipper has been proposed which includes a blade part having a fixed blade and a movable blade, and a main body portion to which the blade part is attached, and cuts hair by causing the movable blade to slide reciprocally with respect to the fixed blade.

### CITATION LIST

### Patent Literature

Patent Literature 1: Unexamined Japanese Patent Publication No. H5-317537

### SUMMARY

### Technical Problem

In such a cutting device, it is preferable to improve operability.

Accordingly, an object of the present disclosure is to provide a cutting device with improved operability.

### Solution to Problem

A cutting device according to one aspect of the present disclosure includes: a main body; and a blade part attached to one end of the main body in a first direction. The main body includes a first main body portion elongated in the first direction; the blade part being attached to one end of the first main body in the first direction. At least one of the following requirement (A) or (B) is satisfied: (A) (i) the main body comprises a second main body portion configured to be connected to the other end of the first main body portion in the first direction, (ii) the second main body portion is connected to the first main body portion via a coupling portion, and (iii) the coupling portion includes a pivot shaft configured to rotate the second main body portion relative to the first main body portion, or (B) the main body comprises a second main body portion connected to the other end of the first main body portion in the first direction in a state where the second main body portion is elongated in a second direction which intersects the first direction.

### Advantageous Effects of Invention

The present disclosure provides a cutting device with improved operability.

### BRIEF DESCRIPTION OF DRAWINGS

FIG. 1 is a perspective view illustrating an example of a hair clipper according to an embodiment.

FIG. 2 is a front view illustrating an example of the hair clipper according to the embodiment.

FIG. 3 is a right side view illustrating an example of the hair clipper according to the embodiment.

FIG. 4 is a left side view illustrating an example of the hair clipper according to the embodiment.

FIG. 5 is a rear view illustrating an example of the hair clipper according to the embodiment.

FIG. 6 is a plan view illustrating an example of the hair clipper according to the embodiment.

FIG. 7 is a rear view illustrating an example of the hair clipper according to the embodiment.

FIG. 8 is a cross-sectional view illustrating an example of the hair clipper according to the embodiment.

FIG. 9 is a right side view illustrating an example of the hair clipper according to the embodiment in a state of being disassembled into a first main body block and a second main body block.

FIG. 10 is a perspective view illustrating an example of the hair clipper according to the embodiment disassembled into the first main body block and the second main body block.

FIG. 11 is a diagram illustrating an example of the hair clipper according to the embodiment, and is a perspective view illustrating a state in which the second main body block is rotated forward with respect to the first main body block.

FIG. 12 a diagram illustrating an example of the hair clipper according to the embodiment, and is a right side view illustrating the state in which the second main body block is rotated forward with respect to the first main body block.

FIG. 13 is a diagram illustrating an example of the hair clipper according to the embodiment, and is a perspective view illustrating a state in which the second main body block is rotated rearward with respect to the first main body block.

FIG. 14 is a diagram illustrating an example of the hair clipper according to the embodiment, and is a right side view illustrating the state in which the second main body block is rotated rearward with respect to the first main body block.

FIG. 15 is an exploded perspective view illustrating an example of the hair clipper according to the embodiment.

FIG. 16 is an exploded perspective view illustrating the first main body block included in the example of the hair clipper according to the exemplary embodiment.

FIG. 17 is an exploded perspective view illustrating the second main body block included in the example of the hair clipper according to the exemplary embodiment.

FIG. 18 is an exploded perspective view illustrating a coupling portion included in the example of the hair clipper according to the exemplary embodiment.

FIG. 19 is a diagram illustrating an example of a gripping method of the hair clipper according to the embodiment, and is a diagram illustrating a first gripping method as viewed obliquely from above.

FIG. 20 is a diagram illustrating an example of a gripping method of the hair clipper according to the embodiment, and is a diagram illustrating the first gripping method as viewed from the right side.

FIG. 21 is a diagram illustrating an example of a gripping method of the hair clipper according to the embodiment, and is a diagram illustrating a second gripping method as viewed obliquely from above.

FIG. 22 is a diagram illustrating an example of a gripping method of the hair clipper according to the embodiment, and is a diagram illustrating a third gripping method as viewed obliquely from above.

FIG. 23 is a diagram illustrating an example of a gripping method of the hair clipper according to the embodiment, and is a diagram illustrating a fourth gripping method as viewed from the left side.

FIG. 24 is a diagram illustrating an example of a gripping method of the hair clipper according to the embodiment, and is a diagram illustrating the fourth gripping method as viewed from the right side.

FIG. 25 is a diagram illustrating an example of a gripping method of the hair clipper according to the embodiment, and is a diagram illustrating a fifth gripping method as viewed from the left side.

FIG. 26 is a diagram illustrating an example of a gripping method of the hair clipper according to the embodiment, and is a diagram illustrating the fifth gripping method as viewed from the right side.

FIG. 27 is a diagram illustrating an example of a gripping method of the hair clipper according to the embodiment, and is a diagram illustrating a sixth gripping method as viewed from the left side.

FIG. 28 is a diagram illustrating an example of a gripping method of the hair clipper according to the embodiment, and is a diagram illustrating the sixth gripping method as viewed from the right side.

FIG. 29 is a diagram for explaining operability when an example of the hair clipper according to the embodiment is used.

FIG. 30 a diagram illustrating a first modification of the hair clipper according to the embodiment, and is a perspective view illustrating a state in which the second main body block is rotated forward with respect to the first main body block.

FIG. 31 is a diagram illustrating the first modification of the hair clipper according to the embodiment, and is a front view illustrating the state in which the second main body block is rotated forward with respect to the first main body block.

FIG. 32 is a diagram illustrating the first modification of the hair clipper according to the embodiment, and is a right side view illustrating the state in which the second main body block is rotated forward with respect to the first main body block.

FIG. 33 is a diagram illustrating the first modification of the hair clipper according to the embodiment, and is a perspective view illustrating the in which the second main body block is rotated rearward with respect to the first main body block.

FIG. 34 is a diagram illustrating the first modification of the hair clipper according to the embodiment, and is a front view illustrating a state in which the second main body block is rotated rearward with respect to the first main body block.

FIG. 35 is a diagram illustrating the first modification of the hair clipper according to the embodiment, and is a right side view illustrating the state in which the second main body block is rotated rearward with respect to the first main body block.

FIG. 36 is a diagram illustrating a second modification of the hair clipper according to the embodiment, and is a perspective view illustrating a state in which the second main body block is rotated rightward with respect to the first main body block.

FIG. 37 is a diagram illustrating a second modification of the hair clipper according to the embodiment, and is a front view illustrating the state in which the second main body block is rotated rightward with respect to the first main body block.

FIG. 38 is a diagram illustrating the second modification of the hair clipper according to the embodiment, and is a right side view illustrating the state in which the second main body block is rotated rightward with respect to the first main body block.

FIG. 39 is a diagram illustrating the second modification of the hair clipper according to the embodiment, and is a perspective view illustrating a state in which the second main body block is rotated leftward with respect to the first main body block;

FIG. 40 is a diagram illustrating the second modification of the hair clipper according to the embodiment, and is a front view illustrating the state in which the second main body block is rotated leftward with respect to the first main body block.

FIG. 41 is a diagram illustrating the second modification of the hair clipper according to the embodiment, and is a right side view illustrating the state in which the second main body block is rotated leftward with respect to the first main body block.

FIG. 42 is a front view illustrating a third modification of the hair clipper according to the embodiment.

FIG. 43 is a right side view illustrating the third modification of the hair clipper according to the embodiment.

### DESCRIPTION OF EMBODIMENTS

Hereinafter, embodiments will be described in detail with reference to the drawings. However, unnecessarily detailed description may be omitted. For example, detailed description of well-known matters or redundant description of substantially the same configuration may be omitted.

The accompanying drawings and the following description are provided to allow those skilled in the art to fully understand the present disclosure, and are not intended to limit the user matter described in the claims.

In the following embodiments and modifications thereof, a hair clipper that cuts hair (that is, an example of hair) of a user will be described as an example of a cutting device.

In the following embodiments and modifications thereof, the reciprocating sliding direction of the movable blade with respect to the fixed blade or the width direction of the hair clipper is defined as a Y direction. Further, the vertical direction or the up-down direction in a state where the hair clipper is disposed such that the blade part is located at the upper portion and the main body portion is located at the lower portion is defined as a Z direction. The front-rear direction of the hair clipper, which is a direction intersecting (for example, orthogonal to) the Y direction and the Z direction, is defined as an X direction.

In the following description of the hair clipper according to the embodiment and modifications thereof, the side where the switch unit is provided is defined as the front side.

### EMBODIMENT

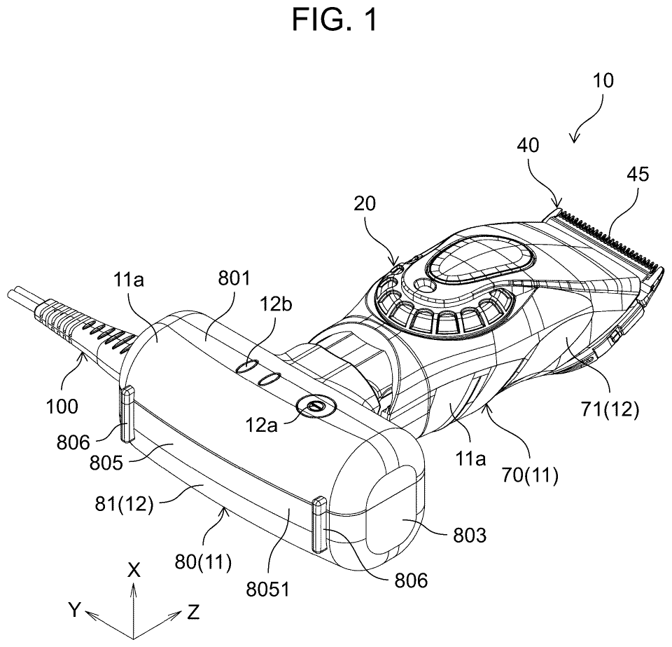

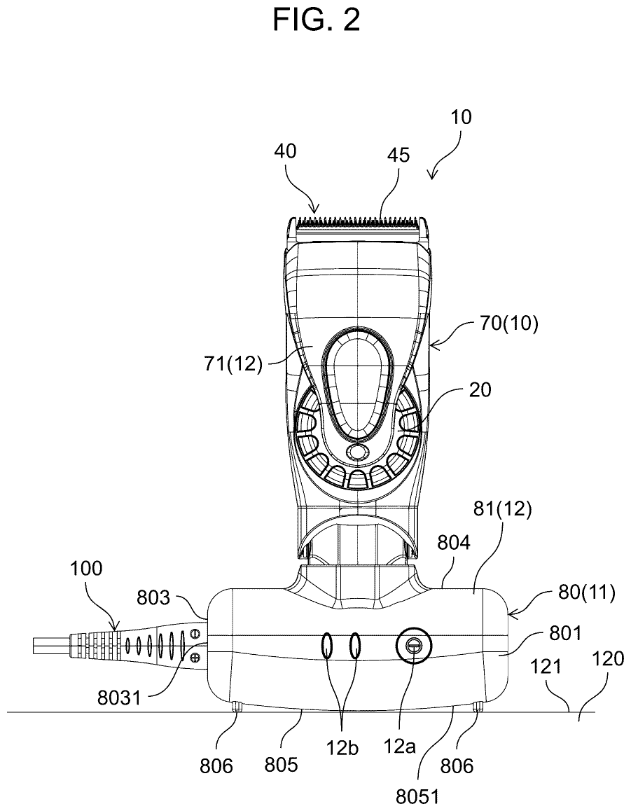

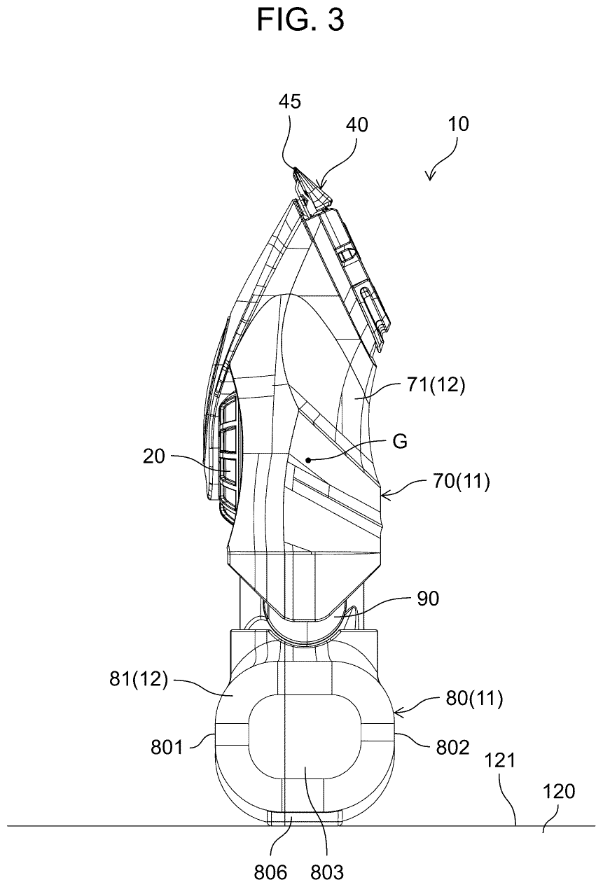

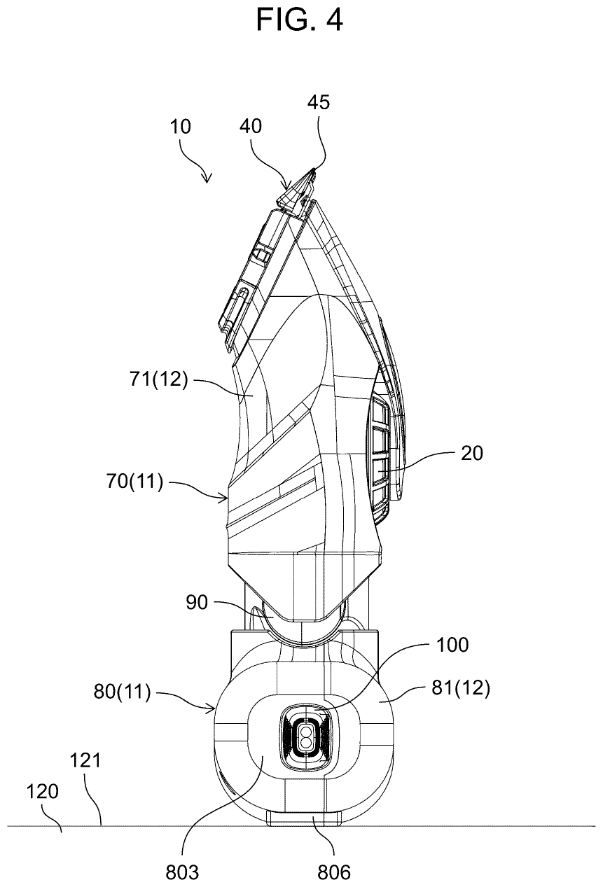

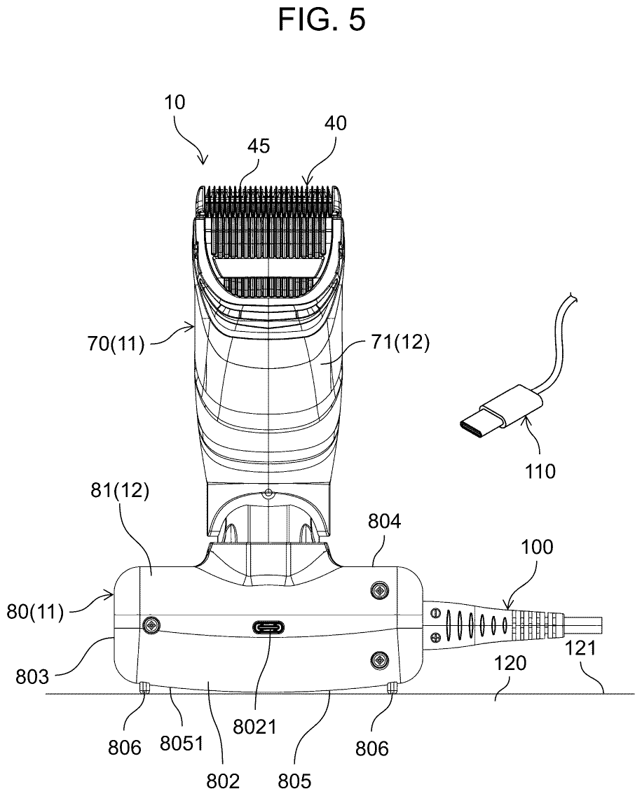

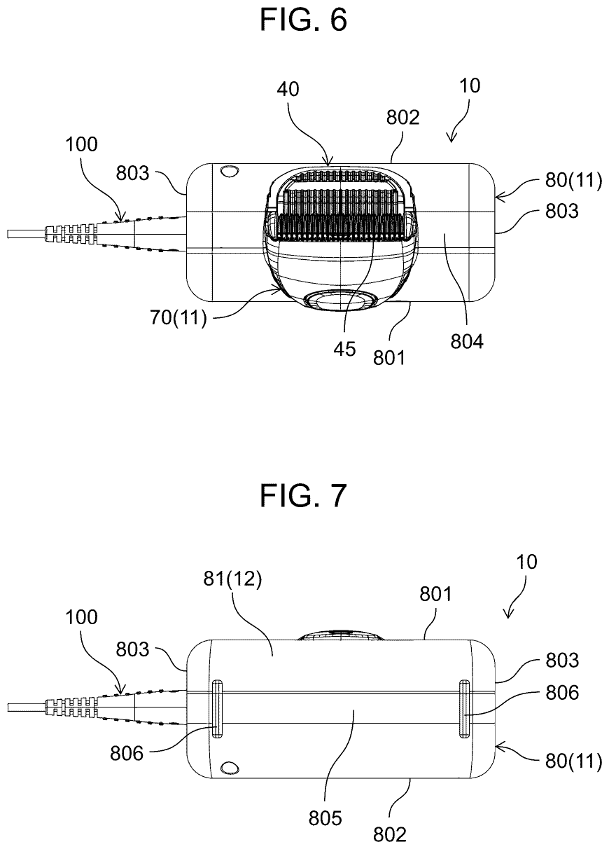

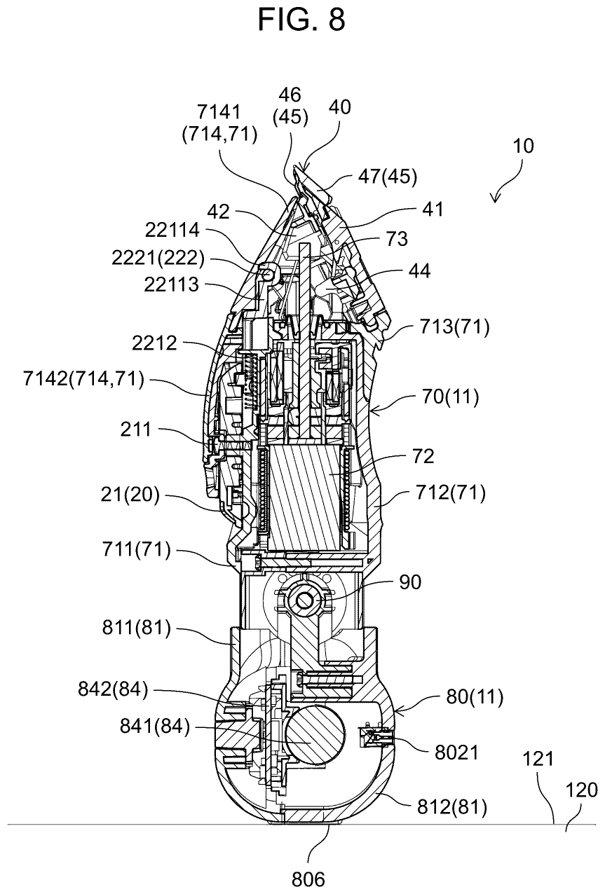

FIG. 1 is a perspective view illustrating an example of a hair clipper 10 according to an embodiment. FIG. 2 is a front view illustrating an example of the hair clipper 10 according to the embodiment. FIG. 3 is a right side view illustrating an example of the hair clipper 10 according to the embodiment. FIG. 4 is a left side view illustrating an example of the hair clipper 10 according to the embodiment. FIG. 5 is a rear view illustrating an example of the hair clipper 10 according to the embodiment. FIG. 6 is a plan view illustrating an example of the hair clipper 10 according to the embodiment. FIG. 7 is a rear view illustrating an example of the hair clipper 10 according to the embodiment. FIG. 8 is a cross-sectional view illustrating an example of the hair clipper 10 according to the embodiment. As shown in FIGS. 1 to 8, the hair clipper 10 according to the present embodiment includes a main body 11 and a blade block 40 detachably attached to the main body 11. The main body 11 includes a grip portion 11a as a grip portion that can be gripped by a hand.

The hair clipper 10 is, for example, a device for treating or conditioning hair H of an user U by cutting the hair H of the user U to a desired length. Specifically, the blade block 40 includes a fixed blade 47 made of metal and a movable blade 46 made of metal that reciprocally slides in the Y direction with respect to the fixed blade 47. The blade block 40 is attached to the main body 11, and then, the movable blade 46 is reciprocally slid in the Y direction with respect to the fixed blade 47 by using a linear motor 72 as a driving source accommodated in the main body 11 as a driving unit, so that the hair H is sandwiched and cut by the fixed blade 47 and the movable blade 46.

Further, in the present embodiment, the main body 11 includes a housing 12 which is formed by using a material such as a synthetic resin and forms an outer shell of the main body 11. A switch portion 12a is attached to a front surface which is a front surface of the housing 12 in such a manner that the switch portion 12a can be pushed inward in a state of being exposed to the outside thereof. Further, a display 12b is formed on the front surface of the housing 12 so that the ON/OFF state of the power supply can be visually confirmed.

In the present embodiment, the housing 12 is formed by joining a plurality of divided bodies, and a cavity is formed inside the housing 12 formed by joining the divided bodies. Various electric components are accommodated in the cavity. The plurality of divided bodies can be joined by, for example, using screws or fitting the divided bodies to each other.

A rechargeable battery 841 as a power supply unit and the linear motor 72 driven by the rechargeable battery 841 are accommodated in the cavity formed inside the housing 12. A drive shaft 73 for transmitting the driving force of the linear motor 72 to the blade block 40 is accommodated in the cavity formed inside the housing 12. In the present embodiment, as shown in FIG. 8, the drive shaft 73 is accommodated in the cavity inside the housing 12 in a state in which the distal end thereof protrudes toward the blade block 40 (more specifically, the upper side in FIG. 8), and is connected to a guide plate 42, which will be described later, of the blade block 40. The method of driving the blade block 40 is not limited to the method described above, and various methods can be used.

Further, a control board 842 for controlling power supply to the linear motor 72 in accordance with a pushing operation of the switch portion 12a exposed to the outside are accommodated in the cavity formed inside the housing 12.

The blade block 40 has a function of cutting the hair H. As shown in FIGS. 8, 15, and 16, the blade block 40 includes a blade part 45 as a blade of the hair clipper formed by arranging the movable blade 46 and the fixed blade 47 so as to face each other. The blade part 45 is configured such that the movable blade bar 461 of the movable blade 46 reciprocally slides in the Y direction with respect to the fixed blade bar 471 of the fixed blade 47.

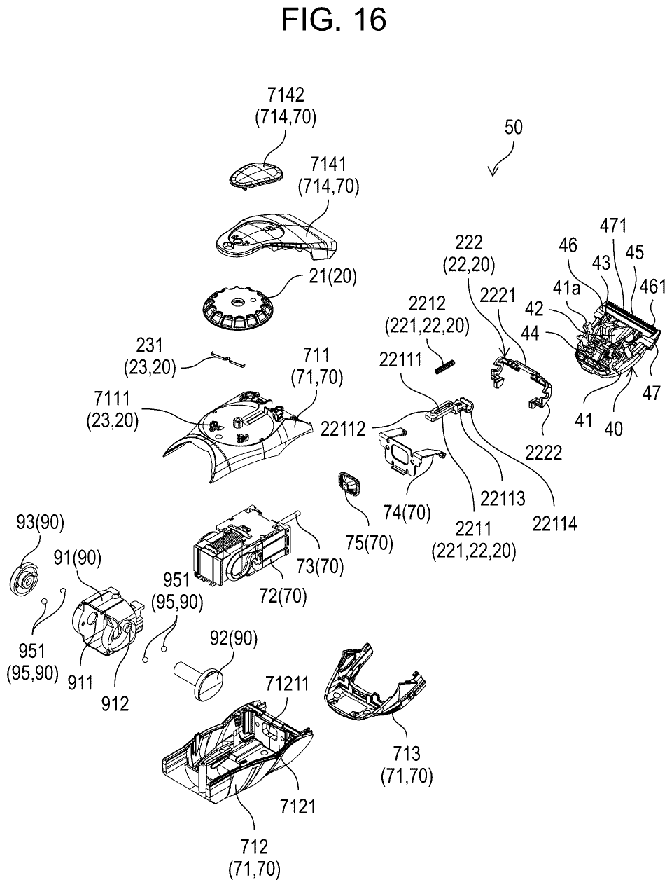

Further, as shown in FIGS. 8 and 16, the blade block 40 includes a resin fixing plate 41 on which the blade part 45 is disposed, and a resin guide plate 42 fixed to the movable blade 46. The blade block 40 includes a push-up spring 43 that is formed of a metal and biases the movable blade 46 toward the fixed blade 47, and a switching lever 44 that is formed of a resin and holds the push-up spring 43. In the present embodiment, the switching lever 44 is held by the fixing plate 41 in a state of being rotatable relative to the fixing plate 41, and can be switched between a raised position and a laid position.

The fixing plate 41 is a member fixed to the main body 11 in a state where the fixed blade 47 is fixed, and includes a hook portion 41a for engaging with the main body 11.

The guide plate 42 is a member that is connected to the drive shaft 73 and reciprocates in the Y direction in a state where the blade block 40 is attached to the main body 11, and the movable blade 46 is fixed to the guide plate 42. The movable blade 46 reciprocally slides in the Y direction with respect to the fixed blade 47 in conjunction with the reciprocal movement of the guide plate 42 in the Y direction.

The push-up spring 43 is a member that biases the movable blade 46 toward the fixed blade 47 to more reliably bring the movable blade bar 461 and the fixed blade bar 471 into sliding contact with each other, and can be formed of, for example, a torsion spring.

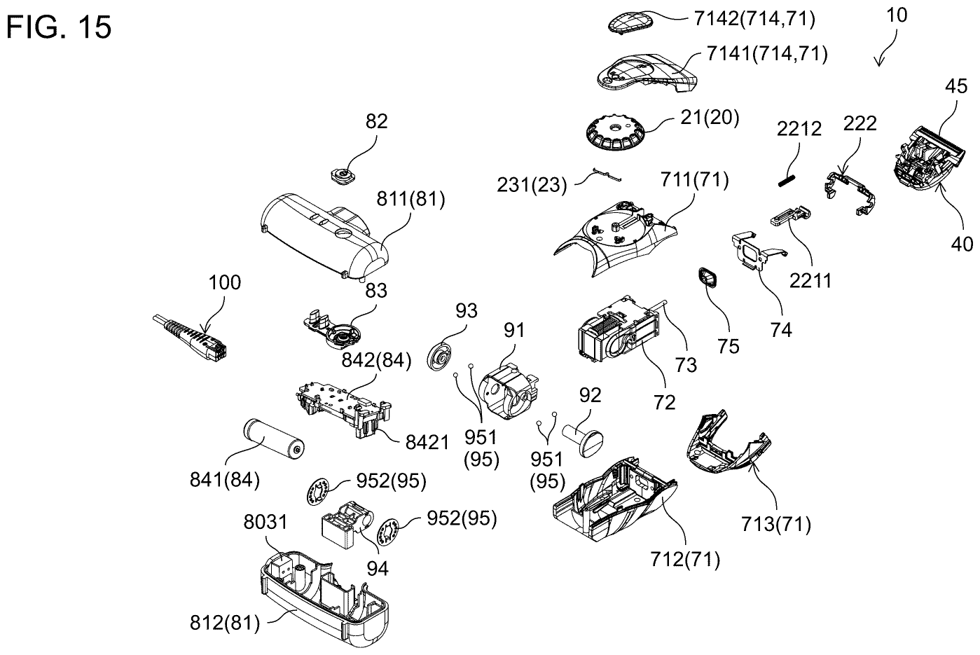

FIG. 15 is an exploded perspective view illustrating an example of the hair clipper 10 according to the embodiment. FIG. 16 is an exploded perspective view illustrating a first main body block 50 included in the example of the hair clipper 10 according to the embodiment. In the present embodiment, as shown in FIGS. 15 and 16, a blade stop spring 74 is fixed to the housing 12 with a screw. The blade stop spring 74 holds the blade block 40 to prevent the blade block 40 from coming off the housing 12.

In the present embodiment, an attachment (not shown) can be attached to the blade block 40, and the cutting height of the hair clipper 10 can be changed by attaching the attachment to the blade block 40.

Further, in the hair clipper 10 according to the present embodiment, the cutting height of the hair H can be changed without using an attachment, and the main body 11 includes a cutting height adjustment mechanism 20. By operating the cutting height adjustment mechanism 20, the switching lever 44 is raised and laid, and the cutting height of the hair H is changed by the raising and lowering operation of the switching lever 44.

As shown in FIGS. 8, 15, and 16, the cutting height adjustment mechanism 20 includes a dial 21 for adjusting the cutting height, which is rotatably attached to the main body 11, and a transmission mechanism 22 that raises and lays the switching lever 44 of the blade block 40 in conjunction with the rotation of the dial 21. In the present embodiment, the dial 21 for adjusting the cutting height is provided closer to the blade block 40 (that is, the upper side of the hair clipper) than to the switch portion 12a on the front surface (that is, in the front direction) of the housing 12 in a state of being rotatable relative to the housing 12. As shown in FIG. 8, the dial 21 can be rotated about a rotation shaft 211 relative to the housing 12.

As shown in FIGS. 8, 15, and 16, the transmission mechanism 22 is accommodated in the cavity formed inside the housing 12, and includes a first conversion mechanism 221 and a second conversion mechanism 222.

Here, the first conversion mechanism 221 is a mechanism that converts the rotation of the dial 21 into linear movement in the Z direction, which is the radial direction of the dial 21, when the dial 21 is rotated clockwise or counterclockwise about the rotation shaft 211. As shown in FIGS. 15 and 16, the first conversion mechanism 221 includes a coupling lever 2211, and the coupling lever 2211 is provided with a rod 22111 having a pin 22112 and a slider 22113 provided at the tip of the rod 22111. When the dial 21 is rotated, the pin 22112 moves in a groove formed in the dial 21 in conjunction with the rotation of the dial 21. Thus, the rod 22111 and the slider 22113 linearly move in the Z direction, which is the radial direction of the dial 21, in conjunction with the movement of the pin 22112 in the groove.

Further, in the present embodiment, as shown in FIG. 8, a coil spring 2212 is attached to the rod 22111, and a load required for rotating the dial 21 is adjusted by the coil spring 2212.

On the other hand, the second conversion mechanism 222 is a mechanism that converts the linear movement converted by the first conversion mechanism 221 into rotation about a rotation axis extending in the Y direction, and includes an operation axis 2221. As shown in FIG. 8, the operation axis 2221 is attached to a hook portion 22114 provided on the slider 22113 in a state of extending in the Y direction, and linearly moves in the Z direction together with the slider 22113.

As shown in FIGS. 15 and 16, the second conversion mechanism 222 includes a rotating member 2222 having one end connected to the operation axis 2221. In the present embodiment, the pair of rotating members 2222 are connected to both ends of the operation axis 2221 in the Y direction (that is, the width direction).

When the operation axis 2221 is linearly moved in the Z direction, the rotating member 2222 rotates in conjunction with the linear movement of the operation axis 2221, and the raising and laying operation of the switching lever 44 is performed in conjunction with the rotation of the rotating member 2222.

In the present embodiment, when the dial 21 is rotated counterclockwise, the slider 22113 and the operation axis 2221 linearly move downward. As the operation axis 2221 moves downward, the rotating member 2222 rotates. At this time, the rotating member 2222 rotates such that one end thereof connected to the operation axis 2221 moves downward and the other end thereof moves upward. In this way, the switching lever 44 is rotated to the raised position against the biasing force of the push-up spring 43, and the movable blade 46 slides toward the tip side (that is, upward) via the push-up spring 43 and the guide plate 42 while a state where the movable blade 46 presses the fixed blade 47 is maintained.

On the other hand, when the dial 21 is rotated clockwise, the slider 22113 and the operation axis 2221 linearly move upward. As the operation axis 2221 moves upward, the rotating member 2222 rotates. At this time, the rotating member 2222 rotates such that the one end thereof connected to the operation axis 2221 moves upward and the other end thereof moves downward. In this way, the switching lever 44 is rotated to the laid position, and the movable blade 46 slides toward the root side (that is, downward) via the push-up spring 43 and the guide plate 42 while a state where the movable blade 46 presses the fixed blade 47 is maintained.

At this time, the movable blade 46 slides on a tapered portion of the fixed blade 47. That is, in the present embodiment, the movable blade 46 is slid between the root side and the tip side on the tapered portion of the fixed blade 47. In this way, the hair cutting height is changed.

In the present embodiment, the cutting height adjustment mechanism 20 includes a holding mechanism 23 configured to hold the dial 21 in a stepwise manner. The holding mechanism 23 holds the dial 21 in the stepwise manner to change the cutting height in the stepwise manner.

Specifically, the holding mechanism 23 includes a holding spring 231 fixed to a fixing portion 7111 provided in the main body 11. The dial 21 is rotated to releasably engage the holding spring 231 with one of a plurality of engaged portions formed on a back surface of the dial 21, so that the dial 21 is held stepwise.

As described above, in the present embodiment, the cutting height can be set in a plurality of steps by operating the dial 21 of the cutting height adjustment mechanism 20.

In the present embodiment, the operability of the hair clipper 10 can be further improved.

Specifically, as shown in FIGS. 1 to 8, the main body 11 includes a first main body portion 70 which is elongated in the Z direction and to which the blade part 45 is attached on the upper side in the Z direction, and a second main body portion 80 which is connected to the lower side of the first main body portion 70.

The second main body portion 80 is connected to the lower side of the first main body portion 70 in a state of being elongated in the Y direction, which is a direction intersecting the Z direction.

As described above, in the present embodiment, the main body 11 includes the first main body portion 70 disposed in a state where the longitudinal direction thereof substantially corresponds to the Z direction as the first direction, and the second main body portion 80 disposed in a state where the longitudinal direction thereof substantially corresponds to the Y direction as the second direction. The second main body portion 80 is connected to the lower end (more specifically, the other end in the first direction) of the first main body portion 70 having the blade part 45 attached to the upper end (more specifically, one end in the first direction) in a state of being elongated in the Y direction.

In this way, the longitudinal direction of the first main body portion 70 and the longitudinal direction of the second main body portion 80 intersect each other, and the entire length of the main body 11 is shortened. Here, the entire length of the main body 11 is a length in the vertical direction from one end portion of the main body 11 to the other end portion of the main body 11, the one end portion being closer to the blade part 45 than the other end portion being. In the present embodiment, the entire length of the main body 11 is about 160 mm, and most of the hair clipper 10 is accommodated in a hand H1. This makes it possible to more reliably prevent the hair clipper 10 from being dropped when the hair clipper 10 is used.

FIG. 29 is a diagram illustrating operability when an example of the hair clipper 10 according to the embodiment is used. By shortening the entire length of the main body 11, as shown in FIG. 29, when the hair H of the user U is clipped using the hair clipper 10, the lower end of the main body 11 can be more reliably prevented from coming into contact with the shoulder of the user U, and the operability of the hair clipper 10 can be further improved. In FIG. 29, a conventional hair clipper is indicated by a two-dot chain line. From the description of FIG. 29, it can be seen that, even in a use method in which the conventional hair clipper comes into contact with the shoulder of the user U, the hair H can be cut without coming into contact with the shoulder of the user U if the hair clipper 10 according to the present embodiment is used. That is, it is understood that the operability can be improved by using the hair clipper 10 shown in the present embodiment, as compared with the conventional hair clipper.

In addition, as in the present embodiment, when the main body 11 is configured by only two of the first main body portion 70 and the second main body portion 80, the shape of the main body 11 is prevented from being a complicated shape, and the main body 11 can have a shape that is more easily gripped.

The lower end (more specifically, the other end in the first direction) of the first main body portion 70 may be connected to the central portion in the Y direction of the second main body portion 80. That is, the second main body portion 80 may be connected to the first main body portion 70 in a state of protruding toward both sides in the Y direction from the first main body portion 70.

This makes it easier to grip the second main body 80 with the hand H1, thereby further improving the operability of the hair clipper 10.

In addition, the longitudinal direction of the second main body portion 80 may substantially correspond to the Y direction, which is the reciprocating direction of the movable blade 46 with respect to the fixed blade 47. That is, the longitudinal direction of the second main body 80 and the reciprocating direction of the movable blade 46 with respect to the fixed blade 47 may be substantially parallel to each other. This makes it easier to bring the blade 45 into contact with the scalp of the user U in a state where the second body 80 is gripped by the hand H1. In addition, it is possible to more easily recognize the reciprocating direction of the movable blade 46 with respect to the fixed blade 47.

Further, in the present embodiment, as shown in FIG. 16, the first main body portion 70 includes a first housing 71 that is formed using a material such as a synthetic resin and forms an outer shell of the first main body portion 70. The first housing 71 is formed by joining a plurality of divided bodies. Specifically, the first housing 71 includes a first front-side housing 711 and a first rear-side housing 712. The first front housing 711 and the first rear-side housing 712 are joined together to form a part of the first housing 71 having a cavity therein. In the present embodiment, the linear motor 72 and the drive shaft 73 are accommodated in the cavity formed in the first housing 71. Specifically, a partition wall 7121 is formed in an upper portion of the first rear-side housing 712, and a through hole 71211 penetrating in the Z direction is formed in a central portion of the partition wall 7121. The linear motor 72 is placed below the partition wall 7121 in the first rear-side housing 712 in a state where the drive shaft 73 is inserted into the through hole 71211 from below. In the present embodiment, the through hole 71211 is closed by a dustproof cover 75 so that water and dust do not come in toward the linear motor 72 when the first main body 70 is formed.

Further, in the present embodiment, the blade block 40 and the cutting height adjustment mechanism 20 are attached to the first main body portion 70. Therefore, in the present embodiment, the first housing 71 includes a blade base 713 that holds the blade block 40, and a cover 714 that covers a part of the dial 21 in a state where the dial 21 is allowed to rotate. The cover 714 includes a cover body 7141 and a finger rest 7142 that is attached to the cover body 7141 and on which a finger such as a thumb F1 can be placed when the hair clipper 10 is gripped. When the cover body 7141 is attached to the first front housing 711, the front side of the blade block 40 is covered with the cover body 7141. In this way, the linear motor 72 and the drive shaft 73 are accommodated in the first main body portion 70 such that the blade part 45 is exposed from the upper end of the first main body portion 70 and that the dial 21 is exposed to the front direction.

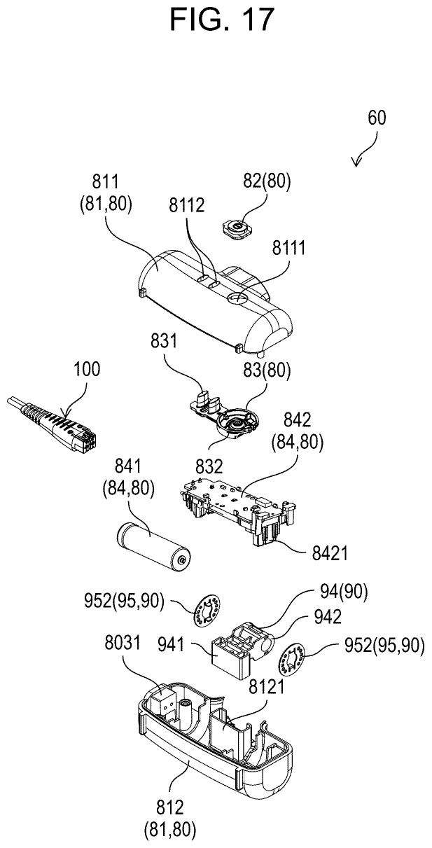

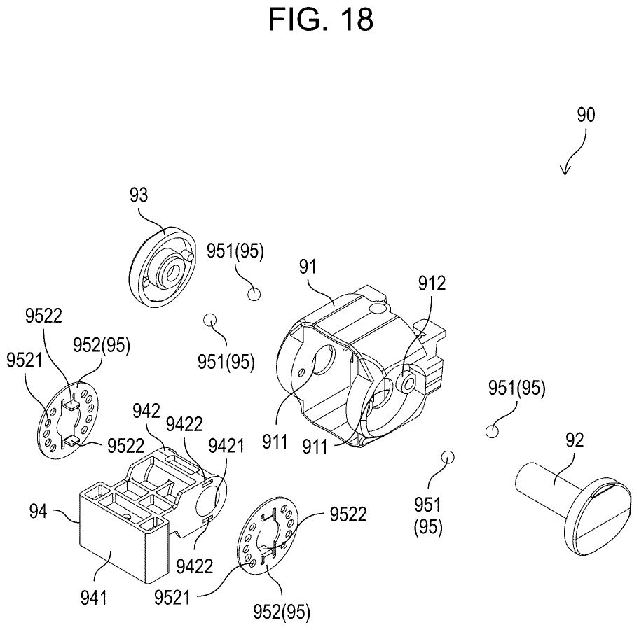

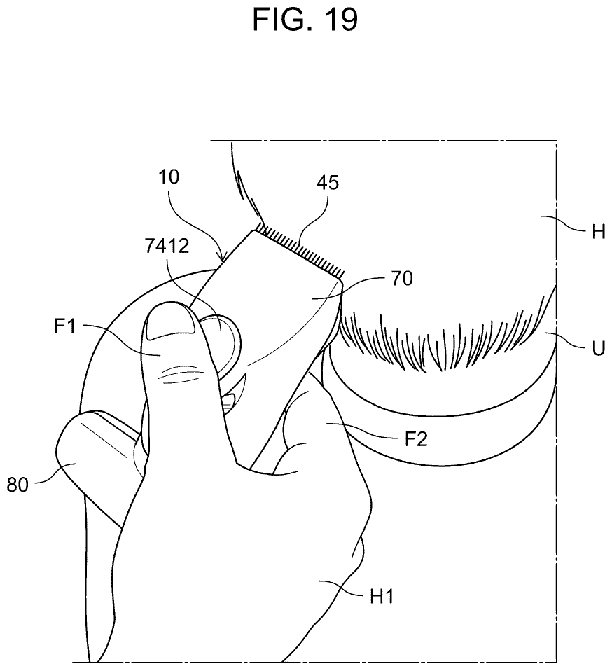

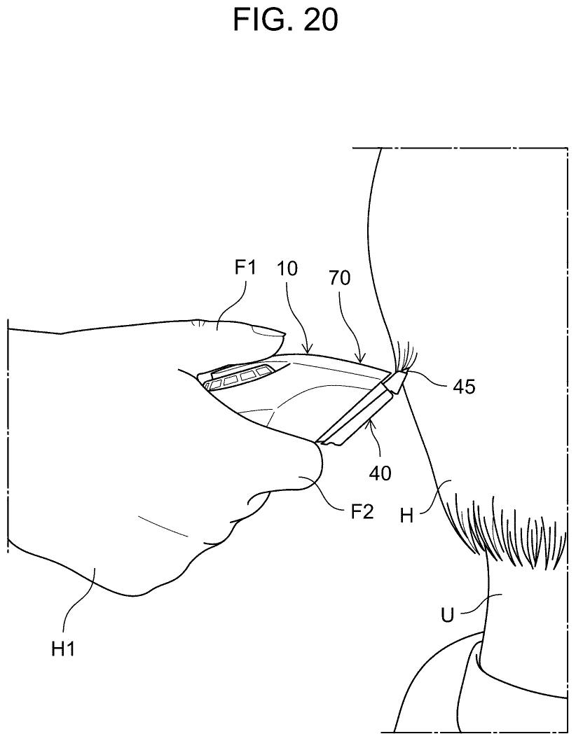

FIG. 17 is an exploded perspective view illustrating the second main body block 60 included in the example of the hair clipper 10 according to the embodiment. As shown in FIG. 17, the second main body portion 80 includes a second housing 81 that is formed using a material such as a synthetic resin and forms an outer shell of the second main body portion 80. The second housing 81 is also formed by joining a plurality of divided bodies. Specifically, the second housing 81 includes a second front housing 811 and a second rear housing 812. The second front housing 811 and the second rear housing 812 are joined together to form the second housing 81 having a cavity formed therein.

In the present embodiment, a rechargeable battery 841 is accommodated in the cavity formed in the second housing 81. Specifically, the rechargeable battery 841 is accommodated in the second main body portion 80 by accommodating, in a cavity formed in the second housing 81, a circuit block 84 which is formed by holding the rechargeable battery 841 on a battery holding base 8421 attached to the control board 842.

Further, in the present embodiment, a through hole 8111 is formed in the second front housing 811, and a switch button 82 is inserted and held in the through hole 8111 in a state where the switch button 82 can protrude and retract in the X direction. Specifically, a cover member 83 is disposed inside the second front housing 811, and a switch button holding portion 832 for holding the switch button 82 is formed in the cover member 83. In a state where the switch button 82 is held by the switch button holding portion 832, the front portion of the switch button 82 is inserted into the through hole 8111 from the inside (that is, the rear side), so that the switch button 82 is held by the second front housing 811 in a state where the switch button 82 can protrude and retract in the X direction. Thus, the switch portion 12a is formed on the front surface 801 of the second main body portion 80.

Further, in the present embodiment, the through hole 8112 is formed in the second front housing 811, and a lamp cover portion 831 formed on the cover member 83 is inserted into the through hole 8112 in a state where the cover member 83 is disposed inside the second front housing 811. Thus, the display 12b is formed on a front surface 801 of the second main body 80. The lamp cover portion 831 covers a light source such as an LED mounted on the control board 842, and has a function of guiding light emitted from the light source.

As described above, in the present embodiment, the linear motor 72 configured to drive the blade part 45 is accommodated in the first main body portion 70, and the rechargeable battery 841 capable of supplying power to the linear motor 72 is accommodated in the second main body portion 80.

In this way, the weight balance between the first main body portion 70 and the second main body portion 80 can be made more uniform, and the center of gravity G of the main body 11 can be positioned at a portion close to the central position thereof. This makes it possible to improve the operability when the hair clipper 10 is gripped in various manners, and to further improve the usability of the hair clipper 10.

It is not necessary that the linear motor 72 is accommodated in the first main body portion 70 and the rechargeable battery 841 is accommodated in the second main body portion 80. The linear motor 72 and the rechargeable battery 841 can be accommodated in various portions of the main body 11.

In addition, the lower surface 805 of the second main body portion 80 may be a curved surface 8051 which is curved to protrude downward in a state where the main body 11 is viewed along the X direction as the third direction. That is, when a state in which the second main body portion 80 is connected to the first main body portion 70 so as to be elongated in the Y direction is viewed along the X direction, the lower surface 805 in the Z direction (i.e., an example of the surface on the other end in the first direction) may have a curved shape so as to protrude in a direction away from the first main body portion 70 (more specifically, so as to protrude downward).

With this configuration, when the side of the main body 11 opposite to the blade part 45 (more specifically, the lower end of the main body 11) is gripped so as to be wrapped with the hand H1, more portions of the lower surface 805 (i.e., an example of the surface on the other end in the first direction) of the second main body portion 80 can be brought into contact with the palm H11. As a result, the second main body portion 80 can be firmly gripped by the hand H1, and the burden on the wrist at the time of comb cutting, which will be described later, can be further reduced.

Note that an upper surface 804 of the second main body portion 80 may be a curved surface that is curved so as to protrude downward in a state where the main body 11 is viewed in the X direction. In this way, the shape of the second main body portion 80 becomes a shape which is similar to a grip of a steering wheel of an automobile, and thus the second main body portion 80 can be more firmly gripped by the hand H1. Further, when the second main body portion 80 is shaped which is similar to a grip of the steering wheel, the fingers gripping the second main body portion 80 are less likely to come off, so that the operability of the hair clipper 10 can be further improved.

Further, the second main body 80 may be provided with a self-standing means capable of causing the main body 11 (i.e., one element of the hair clipper 10) to stand by itself in a state where the blade 45 is located on the upper side of the main body 11. In this way, the hair clipper 10 can be placed in a state where the blade 45 is positioned at the top without using an auxiliary member such as a charging stand.

In the present embodiment, ribs 806 as the self-standing means extending in the X direction and the Z direction are formed on both sides of the lower surface 805 of the second main body 80 in the Y direction. If such ribs 806 are provided on the lower surface 805 of the second main body portion 80 and the lower ends of the ribs 806 are in contact with a placement surface 121 of a placement part 120 such as a desk, the hair clipper 10 can stand on the placement surface 121 in a state where the blade part 45 is located on the upper side of the main body 11.

In this way, when the hair clipper 10 can stand by itself, it is possible to more reliably prevent the blade part 45 from being damaged, and to further improve the appearance of the hair clipper 10 in the placed state. In addition, since it is possible to prevent the blade part 45 from being damaged without using an auxiliary member such as a charging stand or a member for protecting the blade part 45, it is possible to reduce the manufacturing cost. Further, since the operation of placing the hair clipper 10 on the placement surface 121 when the hair clipper 10 is not used and the operation of gripping the hair clipper 10 placed on the placement surface 121 when the hair clipper 10 is used are facilitated, the usability of the hair clipper 10 can be further improved.

Further, a connector 8031 to which an AC cord 100 as an external connection cord is connected may be formed on the side surface 803 of the second main body 80. That is, the connector 8031 to which the AC cord 100 is connected may be formed on the side surface 803 which is a portion serving as an end surface of the second main body portion 80 in the Y direction in a state where the second main body portion 80 is connected to the first main body portion 70 so as to be elongated in the Y direction.

This makes it possible to use the cutting device while supplying external power via the external connection cord. In addition, if the external connection cord is connected to the portion of the second main body portion that is the end surface in the second direction, the external connection cord can be prevented as much as possible from becoming an obstacle when the cutting device Is using while supplying the external power via the external connection cord.

In addition, a USB connector 8021 to which a USB cord 110 is connected may be formed on the second main body portion 80. In this way, the rechargeable battery 841 can be charged using the USB cord 110.

In the present embodiment, the USB connector 8021 is formed on a rear surface 802 of the second main body 80, and the USB cord 110 can be inserted into the USB connector 8021 in a state where the hair clipper 10 is placed on the placement surface 121. Thus, the rechargeable battery 841 can be charged in a state where the hair clipper 10 is placed on the placement surface 121.

The second main body portion 80 may be connected to the first main body portion 70 via the coupling portion 90. The coupling portion 90 may include a pivot shaft 92. In this way, the second main body portion 80 can be rotated relative to the first main body portion 70.

In this way, if the second main body portion 80 can be rotated relative to the first main body portion 70, it is possible to more reliably prevent the second main body portion 80 from interfering with gripping of the first main body portion 70 by the hand H1, and it is possible to provide the hair clipper 10 which is adapted to various manners of gripping.

In the present embodiment, the coupling portion 90 includes a fixing member 91 fixed to the first main body portion 70, and the fixing member 91 is fixed to the first main body portion 70 in a state of holding the linear motor 72.

The fixing member 91 is formed in a shape of a hollow rod which opens downward, and a pair of through holes 911 are formed in a portion defining the Y direction so as to penetrate in the Y direction. The shaft portion of the pivot shaft 92 is inserted in the pair of through holes 911. The coupling portion 90 includes a shaft cap 93 attached to the tip of the shaft portion of the pivot shaft 92. The pivot shaft 92 is attached to the fixing member 91 by attaching the shaft cap 93 to the tip of the shaft portion of the pivot shaft 92 in a state where the pivot shaft 92 is inserted in the through hole 911.

Further, in the fixing member 91, ball holding portions 912 that hold the balls 951 are formed on both sides of each through hole 911 in the Z direction, and the balls 951 are held by the ball holding portions 912 in a state of protruding outward in the Y direction. Therefore, in the present embodiment, two balls 951 are held on one side in the Y direction, and two balls 951 are held on the other side in the Y direction.

In addition, the coupling portion 90 includes a rotating member 94 that is rotatably attached to the shaft portion of the pivot shaft 92 in a state of being fixed to the second main body portion 80. In the present embodiment, the rotating member 94 includes an accommodating wall 941 accommodated and held in a holding wall 8121 formed in the second rear housing 812, and a rotating portion 942 rotatably attached to the shaft portion of the pivot shaft 92. A through hole 9421 is formed in the rotating portion 942 so as to penetrate in the Y direction. In a state where the rotating portion 942 is inserted into the fixing member 91 from the lower side and where the pair of through holes 911 and the through hole 9421 communicate with each other, the shaft portion of the pivot shaft 92 is inserted into the pair of through holes 911 and the through hole 9421. Thus, the rotating member 94 is rotatably attached to the fixing member 91.

In this way, the second main body portion 80 can be rotated forward and backward relative to the first main body portion 70.

Further, when the second main body portion 80 is relatively rotated in the front-rear direction with respect to the first main body portion 70 to reach a predetermined angular position, the rotation of the second main body portion 80 with respect to the first main body portion 70 may be restricted. The rotation of the second main body portion 80 with respect to the first main body portion 70 may be also restricted, even when the second main body portion 80 reaches an angular position different from the predetermined angular position.

As described above, the coupling portion 90 may include a holding mechanism 95 configured to hold the second main body portion 80 rotated in the front-rear direction relative to the first main body portion 70 in a stepwise manner. This allows the hair clipper 10 to be adapted to various manners of gripping. Further, if the second main body portion 80 can be held in a predetermined state, the second main body portion 80 is prevented from moving relative to the first main body portion 70 during the use of the hair clipper 10, and thus, the usability of the hair clipper 10 can be further improved.

In the present embodiment, the balls 951 fixed to the fixing member 91 and ball receivers 952 fixed to the rotating member 94 constitute the holding mechanism 95.

A plurality of ball receiving holes 9521 are formed in each of the ball receivers 952 along the circumferential direction thereof. Each of the balls 951 is fitted into one of the plurality of ball receiving holes 9521, so that the rotation of the second main body portion 80 with respect to the first main body portion 70 is restricted.

In the present embodiment, each of the ball receivers 952 is fixed to the rotating member 94 in a state of being prevented from rotating by inserting holding pieces 9522 into insertion holes 9422 formed in the rotating portion 942. Therefore, when the rotating member 94 is rotated relative to the fixed member 91 and the pivot shaft 92, the ball receivers 952 also rotate in conjunction with the rotation of the rotating member 94. When the ball receivers 952 rotate, the fitting between each ball 951 and the specific ball receiving hole 9521 is released. When the ball receiver 952 rotates in a state in which the fitting between each ball 951 and the specific ball receiving hole 9521 is released, each ball 951 is fitted into another ball receiving hole 9521 adjacent to the specific ball receiving hole 9521 along the circumferential direction of the ball receiver 952. In this way, the rotation of the second main body portion 80 with respect to the first main body portion 70 is restricted in a state of the second main body portion 80 reaches an angular position different from the predetermined angular position.

The coupling portion 90 having such a configuration can be assembled by, for example, the following method.

First, the balls 951 are held by the ball holding portions 912 formed in the fixing member 91.

Next, the rotating portion 942 of the rotating member 94 is inserted into the fixing member 91 from below so that the pair of through holes 911 and the through hole 9421 communicate with each other.

Next, the holding piece 9522 of the ball receiver 952 is inserted into the insertion hole 9422 formed in the rotating portion 942 from the outside in the Y direction (that is, the width direction and the second direction), and the ball receivers 952 are held to the rotating portion 942 in a state where the ball 951 and the fixing member 91 are provided therebetween. At this time, the through holes of the ball receiver 952 communicate with the pair of through holes 911 and the through-hole 9421.

Next, the shaft portion of the rotation shaft 92 is inserted into the through holes of the ball receivers 952, the pair of through holes 911, and the through hole 9421.

Finally, the shaft cap 93 is attached to the tip of the shaft portion of the pivot shaft 92.

In this way, the coupling portion 90 is assembled.

The second main body 80 and the first main body 70 are attached to the coupling portion 90 to provide the hair clipper 10 in which the second main body 80 can be rotated relative to the first main body 70 and the rotation angle of the second main body 80 with respect to the first main body 70 can be changed and held in a stepwise manner.

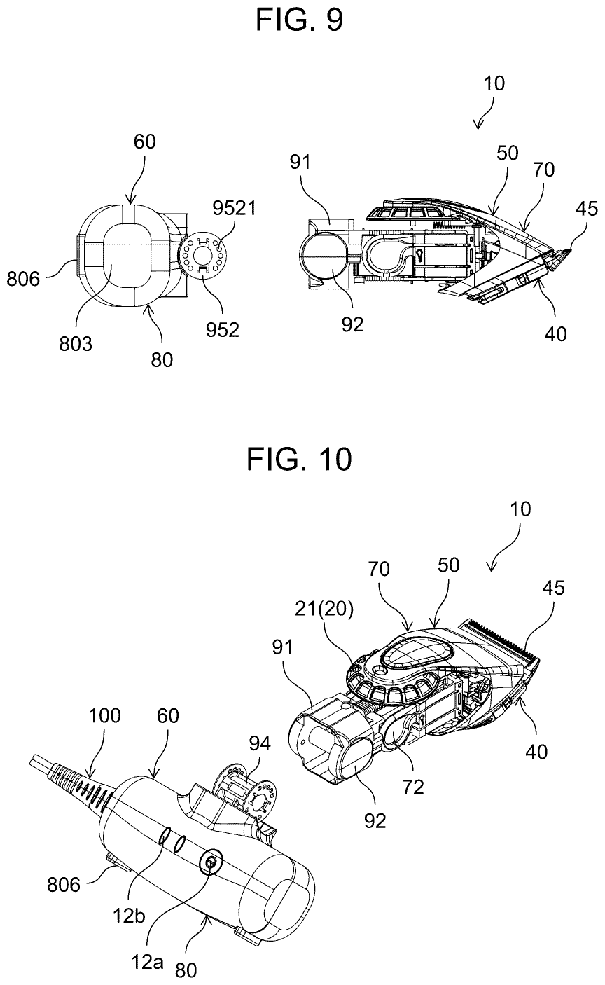

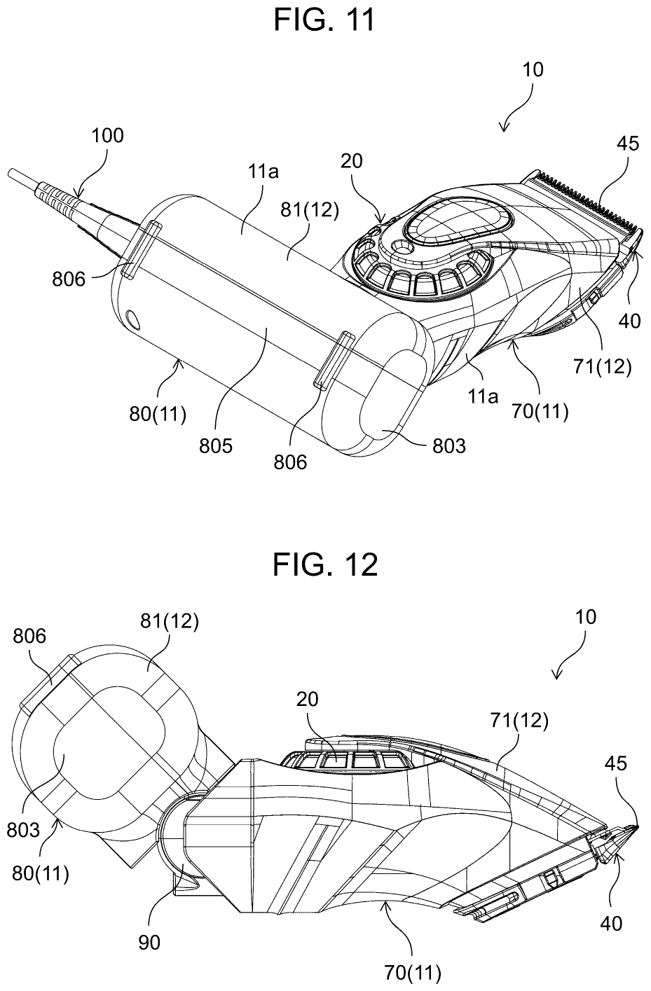

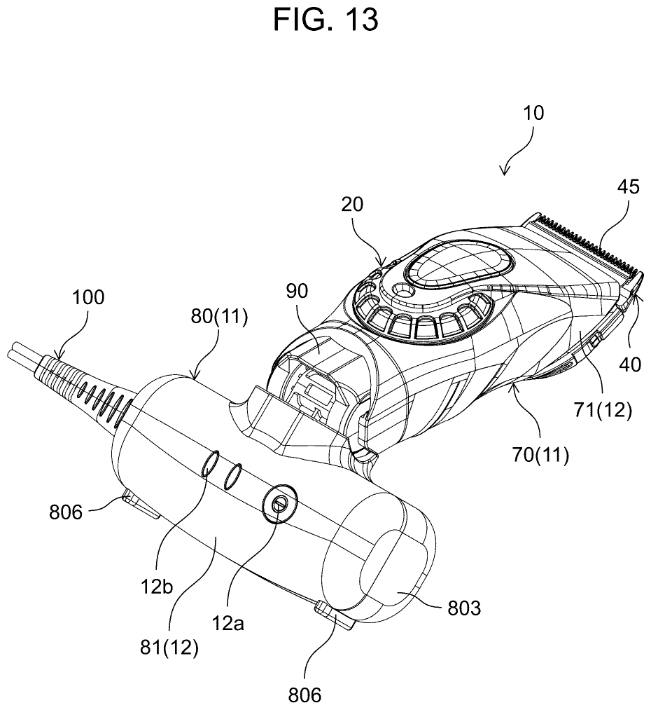

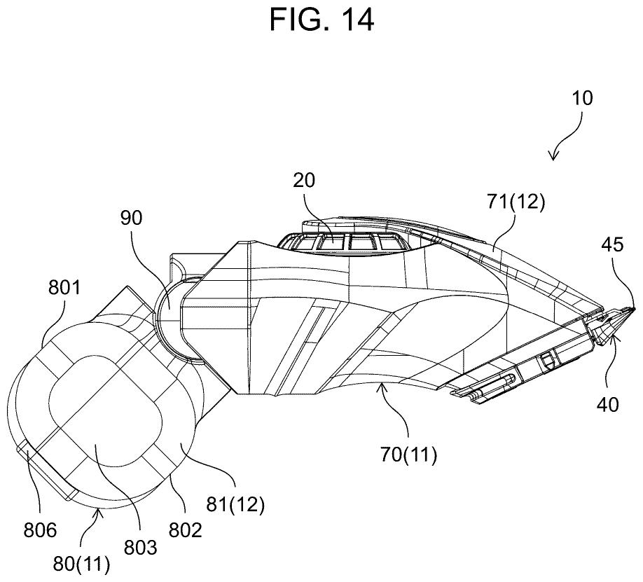

FIG. 9 is a right side view illustrating an example of the hair clipper 10 according to the embodiment in a state of being disassembled into the first main body block 50 and the second main body block 60. FIG. 10 is a perspective view illustrating an example of the hair clipper 10 according to the embodiment in a state of being disassembled into the first main body block 50 and the second main body block 60. In the present embodiment, as shown in FIGS. 9 and 10, the second main body block 60 including the second main body 80, the rotating member 94, and the ball receiver 952 rotates forward and backward relative to the first main body block 50 including the first main body 70, the fixing member 91, the pivot shaft 92, the shaft cap 93, and the ball 951. Although FIGS. 9 and 10 show the first main body block 50 in a state where the first front housing 711 and the first rear-side housing 712 are removed, the first main body block 50 actually includes the first front housing 711 and the first rear-side housing 712.

Even when the hair clipper 10 described in the present embodiment is used in various manners of gripping, it is possible to suppress a decrease in operability.

Next, a method of gripping the hair clipper 10 according to the present embodiment will be described. The gripping method described below is merely an example, and the hair clipper 10 can be gripped by a method other than the method described below.

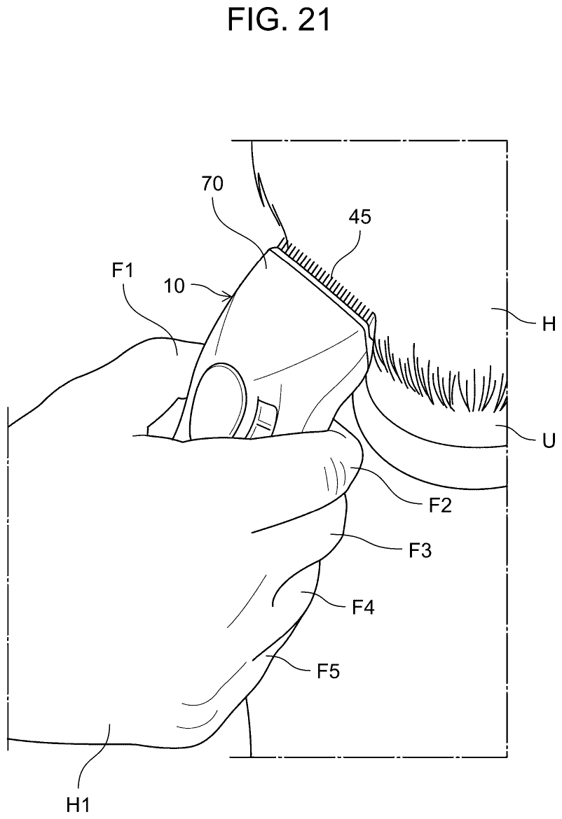

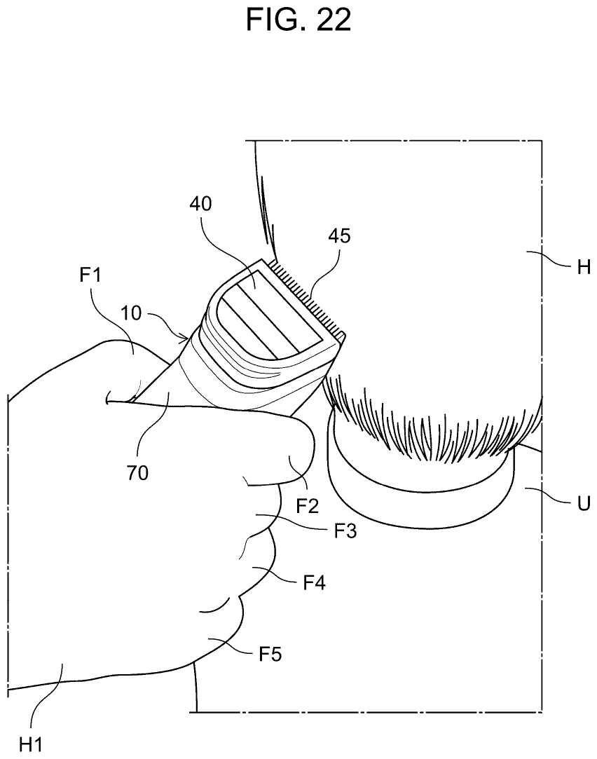

FIG. 19 is a diagram illustrating an example of a gripping method of the hair clipper 10 according to the embodiment, and is a diagram illustrating a first gripping method as viewed obliquely from above. FIG. 20 is a diagram illustrating an example of a gripping method of the hair clipper 10 according to the embodiment, and is a diagram illustrating a first gripping method as viewed from the right side. The hair clipper 10 can be gripped, for example, by the method shown in FIGS. 19 and 20. FIGS. 19 and 20 illustrate how to hold the hair clipper 10 in a state where the thumb F1 is placed on the finger rest 7142 and the other fingers (that is, an index finger F2, a middle finger F3, a ring finger F4, and a little finger F5) are placed on the rear surface of the main body 11. That is, in the gripping manner shown in FIGS. 19 and 20, the hair clipper 10 is held in a state where the right side surface of the first main body portion 70 is wrapped by the hand H1.

Even when the hair clipper 10 is gripped by such a method, the hair clipper 10 can be used with good operability.

For example, when the hair clipper 10 is held in such a manner, the hair clipper 10 can be moved from the lower side to the upper side to cut (i.e., cut up) the hair H of the user U. At this time, in the hair clipper 10 according to the present embodiment, since the entire length of the main body 11 is short, the lower end of the main body 11 can be more reliably prevented from coming into contact with the shoulder of the user U. Thus, the operability of the hair clipper 10 can be further improved.

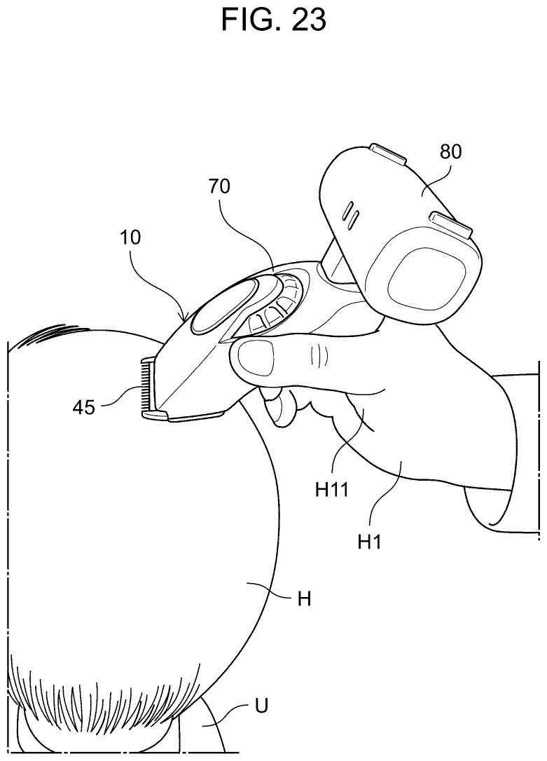

FIG. 21 is a diagram illustrating an example of a gripping method of the hair clipper 10 according to the embodiment, and is a diagram illustrating a second gripping method as viewed obliquely from above. It is also possible to grip the hair clipper 10 in the manner shown in FIG. 21. FIG. 21 illustrates how to hold the hair clipper 10 in a state where the thumb F1 is placed on the left side portion of the first main body portion 70 and where the other fingers (that is, the index finger F2, the middle finger F3, the ring finger F4, and the little finger F5) are placed on the rear surface of the main body 11. That is, in the holding manner shown in FIG. 21, the hair clipper 10 is held in a state where the front surface of the first main body portion 70 is wrapped by the hand H1.

Even when the hair clipper 10 is gripped by such a method, the hair clipper 10 can be used with good operability.

For example, when the hair clipper 10 is held in such a manner, the hair clipper 10 can be moved from the lower side to the upper side to cut (i.e., cut up) the hair H of the user U. At this time, in the hair clipper 10 according to the present embodiment, since the entire length of the main body 11 is short, the lower end of the main body 11 can be more reliably prevented from coming into contact with the shoulder of the user U, and the operability of the hair clipper 10 can be further improved.

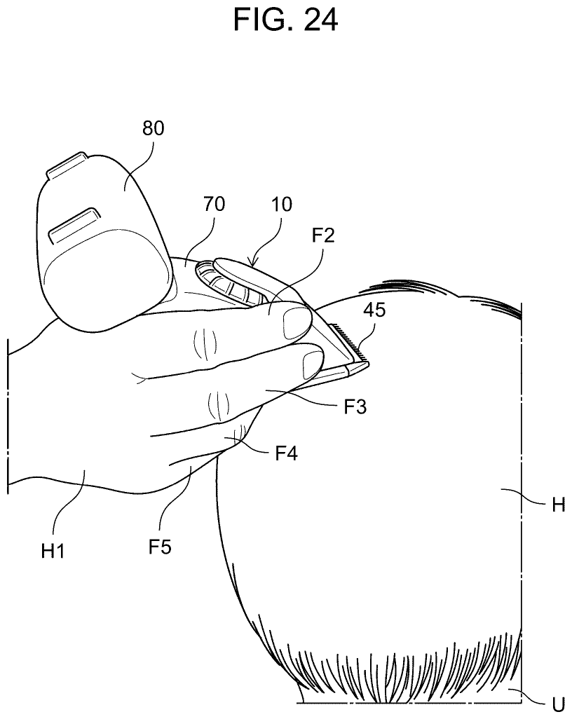

FIG. 22 is a diagram illustrating an example of a gripping method of the hair clipper 10 according to the embodiment, and is a diagram illustrating a third gripping method as viewed obliquely from above. It is also possible to grip the hair clipper 10 in the manner shown in FIG. 22. FIG. 22 shows how to hold the hair clipper 10 in a state where the thumb F1 is placed on the right side portion of the first main body portion 70 and where the other fingers (that is, the index finger F2, the middle finger F3, the ring finger F4, and the little finger F5) are placed on the front surface of the main body 11. That is, in the holding manner shown in FIG. 22, the hair clipper 10 is held in a state where the rear surface of the first main body portion 70 is wrapped by the hand H1. Hereinafter, the state in which the rear surface of the first main body portion 70 is wrapped by the hand H1 may be referred to as “reversed hand”.

Even when the hair clipper 10 is gripped by such a method, the hair clipper 10 can be used with good operability.

For example, when the hair clipper 10 is held in such a manner, the hair clipper 10 can be moved downward from above to cut the hair H of the user U (more specifically, to adjust the length of the hair finely).

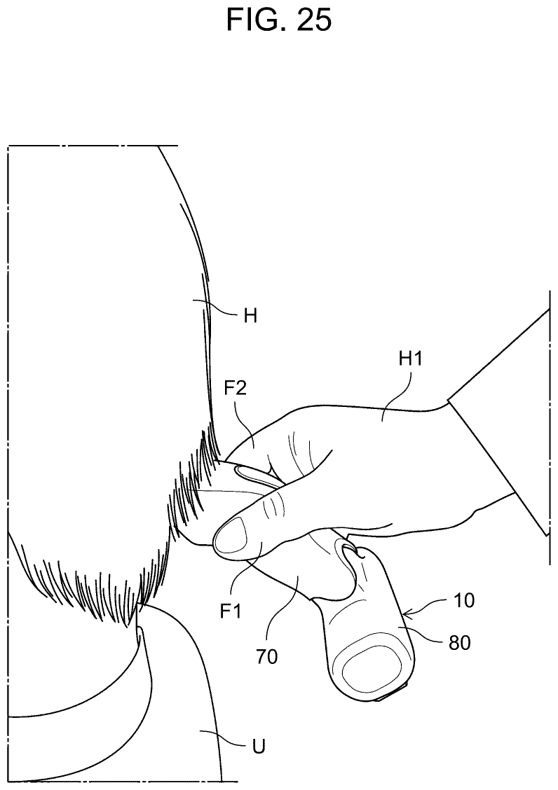

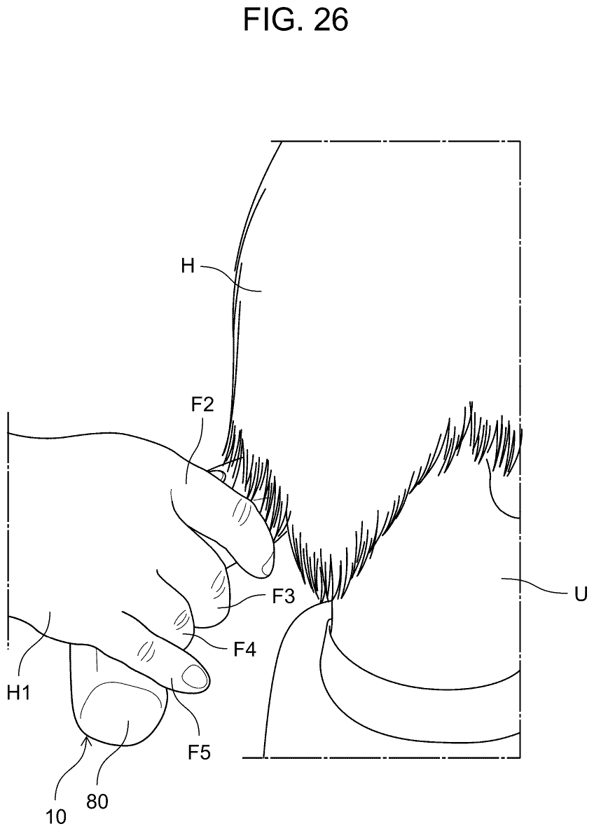

FIG. 23 is a diagram illustrating an example of a gripping method of the hair clipper 10 according to the embodiment, and is a diagram illustrating a fourth gripping method as viewed from the left side. FIG. 24 is a diagram illustrating an example of a gripping method of the hair clipper 10 according to the embodiment, and is a diagram illustrating the fourth gripping method as viewed from the right side. It is also possible to grip the hair clipper 10 in the manner shown in FIGS. 23 and 24. FIGS. 23 and 24 show how to hold the hair clipper 10 in a state where the side portion of the first main body portion 70 is sandwiched by the thumb F1, the index finger F2, and the middle finger F3 and where the ring finger F4 and the little finger F5 are placed on the rear surface of the main body 11. That is, in the holding manner shown in FIGS. 23 and 24, the hair clipper 10 is held in a state of gripping a pen. At this time, the second main body portion 80 is rotated forward with respect to the first main body portion 70. In this way, the second main body portion 80 does not interfere with the hand H1 when the first main body portion 70 is gripped.

Even when the hair clipper 10 is gripped by such a method, the hair clipper 10 can be used with good operability.

For example, when the hair clipper 10 is held in such a manner, the hair clipper 10 can be moved from the rear to the front to cut the hair H at the top of the head of the user U.

FIG. 25 is a diagram illustrating an example of a gripping method of the hair clipper 10 according to the embodiment, and is a diagram illustrating a fifth gripping method as viewed from the left side. FIG. 26 is a diagram illustrating an example of a gripping method of the hair clipper 10 according to the embodiment, and is a diagram illustrating the fifth gripping method as viewed from the right side. It is also possible to grip the hair clipper 10 in the manner shown in FIGS. 25 and 26. FIGS. 25 and 26 show how to hold the hair clipper 10 in a state where the thumb F1 is placed on the left side portion of the first main body portion 70, where the index finger F2 and the middle finger F3 are placed on the right side portion of the first main body portion 70, and where the ring finger F4 and the little finger F5 are placed on the upper surface 804 of the second main body portion 80. That is, in the holding manner shown in FIGS. 25 and 26, the hair clipper 10 is held in a state where the side portions of the first main body portion 70 are sandwiched by the fingers while the front surface of the first main body portion 70 is wrapped by the hand H1. At this time, the second main body portion 80 is rotated rearward with respect to the first main body portion 70. In this way, the second main body portion 80 does not interfere with the hand H1 when the first main body portion 70 is sandwiched.

Even when the hair clipper 10 is gripped by such a method, the hair clipper 10 can be used with good operability.

For example, when the hair clipper 10 is held in such a manner, the hair clipper 10 can be moved from the lower side to the upper side to cut (i.e., cut up) the hair H of the user U. At this time, in the hair clipper 10 according to the present embodiment, since the entire length of the main body 11 is short, the lower end of the main body 11 can be more reliably prevented from coming into contact with the shoulder of the user U. Thus, the operability of the hair clipper 10 can be further improved.

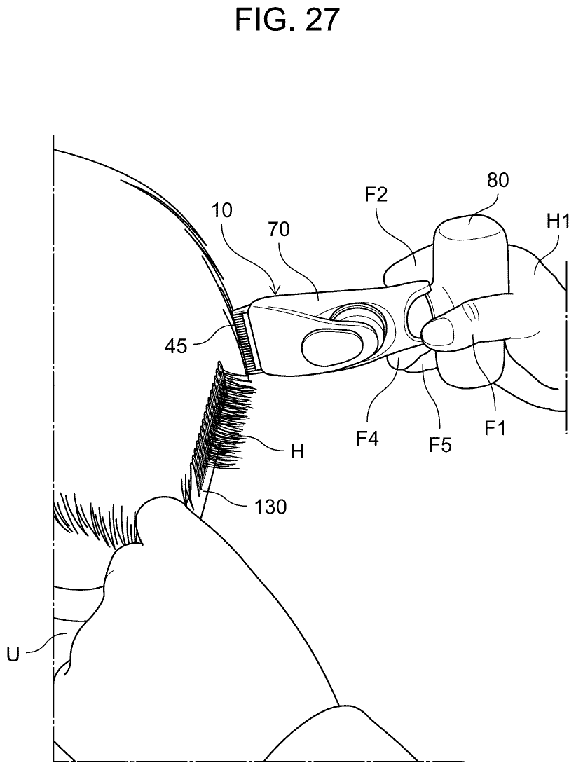

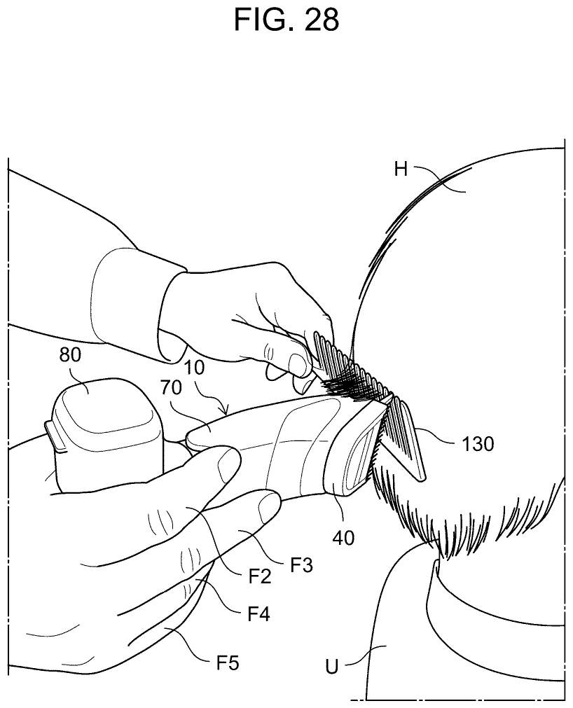

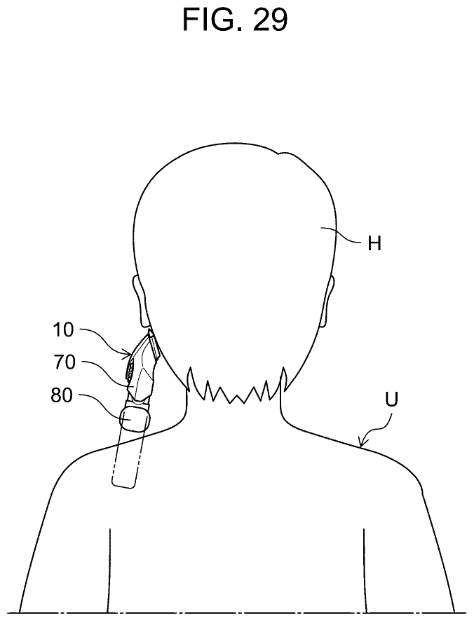

FIG. 27 is a diagram illustrating an example of a gripping method of the hair clipper 10 according to the embodiment, and is a diagram illustrating a sixth gripping method as viewed from the left side. FIG. 28 is a diagram illustrating an example of a gripping method of the hair clipper according to the embodiment, and is a diagram illustrating the sixth gripping method as viewed from the right side. It is also possible to grip the hair clipper 10 in the manner shown in FIGS. 27 and 28. FIGS. 27 and 28 show how to hold the hair clipper 10 in a state where the lower surface 805 of the second main body portion 80 is in contact with the palm H11, where the thumb F1 is placed on the front surface of the second main body portion 80, and where the other fingers (that is, the index finger F2, the middle finger F3, the ring finger F4, and the little finger F5) are placed on the rear surface of the second main body portion 80 and the rear surface of the first main body portion 70. That is, in the holding manner shown in FIGS. 27 and 28, the hair clipper 10 is held in a state where the front and rear of the second main body portion 80 are sandwiched by the fingers while the front end (more specifically, the lower surface 805) of the second main body portion 80 is opposed to the palm H11 and wrapped by the hand H1.

Even when the hair clipper 10 is gripped by such a method, the hair clipper 10 can be used with good operability.

For example, when the hair clipper 10 is held in such a manner, the hair H (for example, head hair) of the user U can be cut using the comb 130. Hereinafter, hair cutting using a comb may be referred to as comb cutting. At this time, in the hair clipper 10 according to the present embodiment, since the entire length of the main body 11 is short, the center of gravity G of the hair clipper 10 can be positioned closer to the palm H11 than to the fingertips. This allows the hair clipper 10 to be stably held in the manner shown in FIGS. 27 and 28. As a result, it is possible to more reliably suppress shaking of the hair clipper 10 during use of the hair clipper 10.

When the hair clipper 10 is held in the manner shown in FIGS. 27 and 28, the main body 11 can be held without bending the wrist, so that the burden on the wrist during comb cutting can be further reduced.

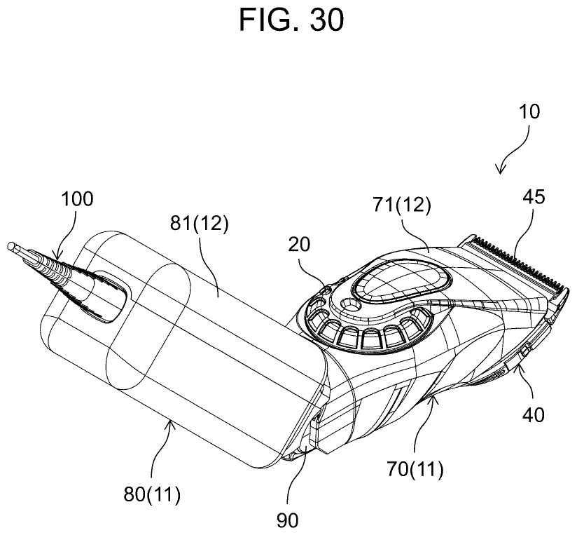

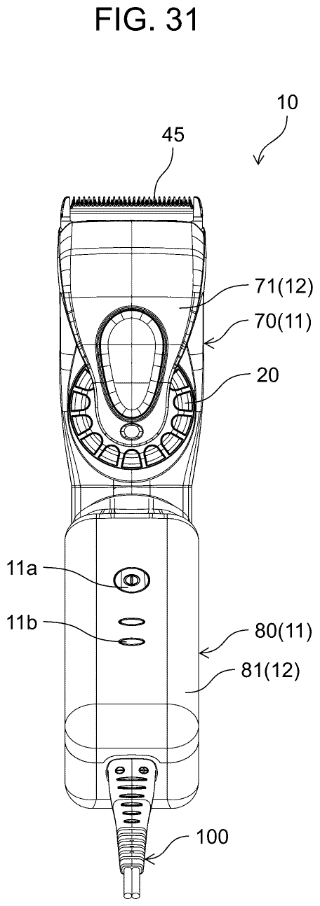

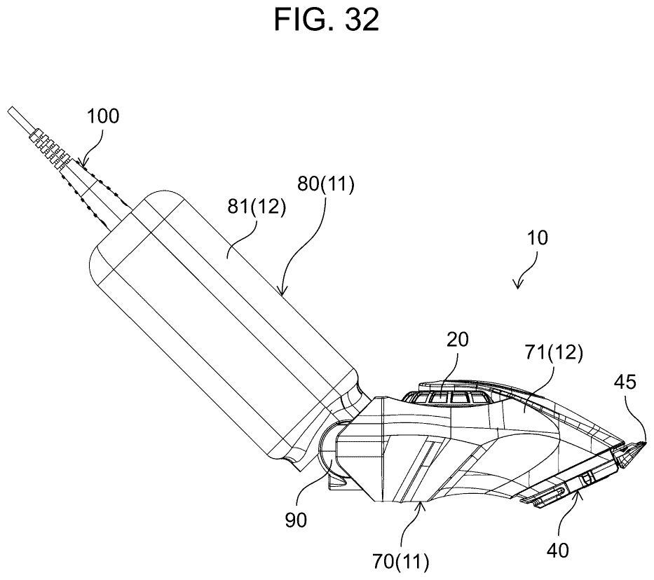

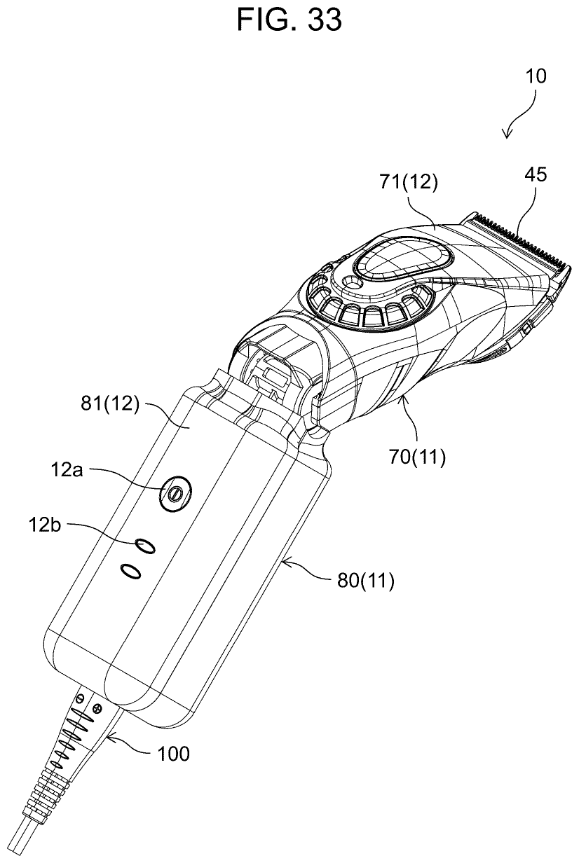

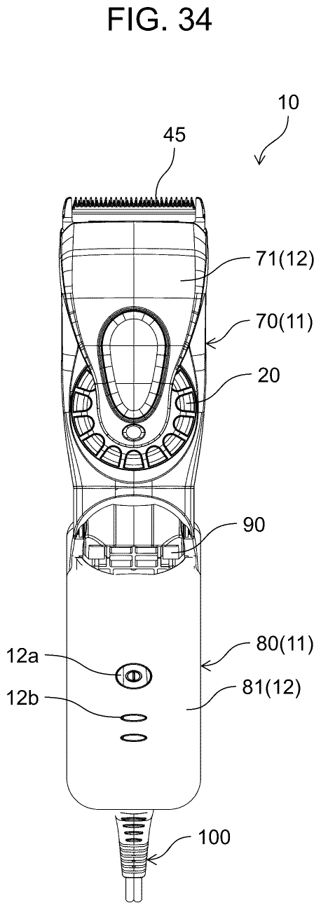

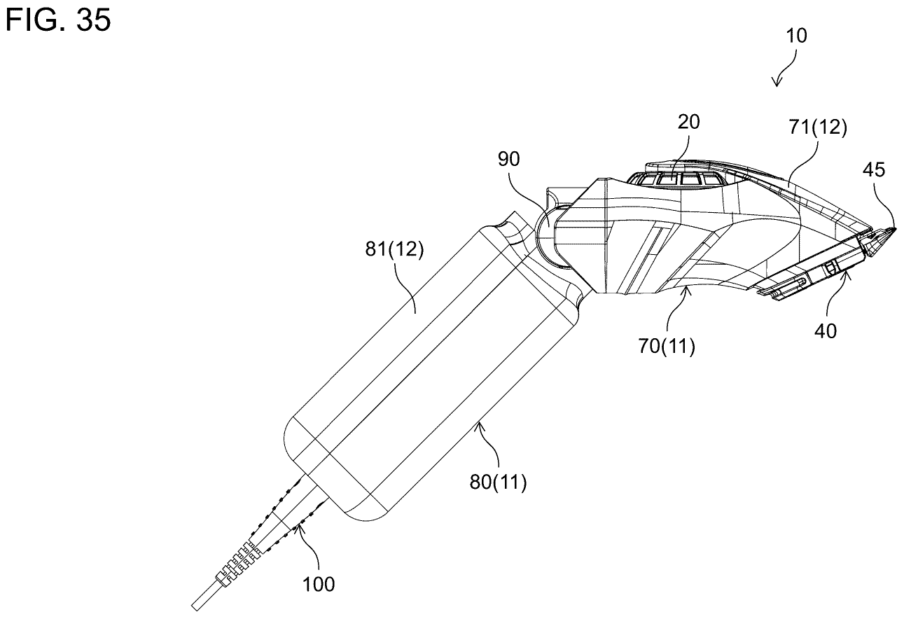

The hair clipper 10 may have a configuration shown in FIGS. 30 to 35. FIG. 30 is a diagram illustrating a first modification of the hair clipper 10 according to the embodiment, and is a perspective view illustrating a state in which the second main body block 60 is rotated forward with respect to the first main body block 50. FIG. 31 is a diagram illustrating the first modification of the hair clipper 10 according to the embodiment, and is a front view illustrating the state in which the second main body block 60 is rotated forward with respect to the first main body block 50. FIG. 32 is a right side view showing the first modification of the hair clipper 10 according to the embodiment in the state where the second main body block 60 is rotated forward with respect to the first main body block 50. FIG. 33 is a diagram illustrating the first modification of the hair clipper 10 according to the embodiment, and is a perspective view illustrating a state in which the second main body block 60 is rotated rearward with respect to the first main body block 50. FIG. 34 is a diagram illustrating the first modification of the hair clipper 10 according to the embodiment, and is a front view illustrating the state in which the second main body block 60 is rotated rearward with respect to the first main body block 50. FIG. 35 is a right side view showing the first modification of the hair clipper 10 according to the embodiment in the state where the second main body block 60 is rotated rearward with respect to the first main body block 50.

The hair clipper 10 shown in FIGS. 30 to 35 is also elongated in the Z direction, and includes a first main body 70 to which the blade 45 is attached on the upper side in the Z direction, and the second main body 80 connected to the lower side of the first main body 70.

The second main body portion 80 can be connected to the lower side of the first main body portion 70 in an elongated state in a direction intersecting the Z direction.

As described above, in FIGS. 30 to 35, the main body 11 includes the first main body portion 70 which is disposed in a state where the longitudinal direction substantially thereof corresponds to the Z direction as the first direction, and the second main body portion 80 which can be disposed in a state where the longitudinal direction thereof substantially corresponds to the X direction as the second direction, which is a direction intersecting the Z direction.

Further, also in FIGS. 30 to 35, the second main body portion 80 may be connected to the first main body portion 70 via the coupling portion 90. That is, the second main body portion 80 can be rotated relative to the first main body portion 70.

FIGS. 30 to 35 illustrate an example in which one end of the second main body portion 80 in the longitudinal direction is connected to the lower side of the first main body portion 70 via the coupling portion 90. In the example, the second main body portion 80 can be rotated forward and backward relative to the first main body portion 70 using the Y direction as an axis.

Therefore, FIGS. 30 to 35 illustrate the hair clipper 10 in which the second main body portion 80 is connected to the first main body portion 70 in a state where the second main body portion 80 can protrude only toward one side in the second direction with respect to the first main body portion 70.

This also improves the operability of the hair clipper 10.

As described above, the hair clipper 10 shown in FIGS. 30 to 35 can also achieve substantially the same operations and effects as those of the hair clipper 10 shown in the above embodiment.

In the hair clipper 10 shown in FIGS. 30 to 35, the longitudinal direction of the second main body portion 80 can substantially corresponds to the longitudinal direction of the first main body portion 70, and a configuration substantially similar to that of a conventional hair clipper can be selected.

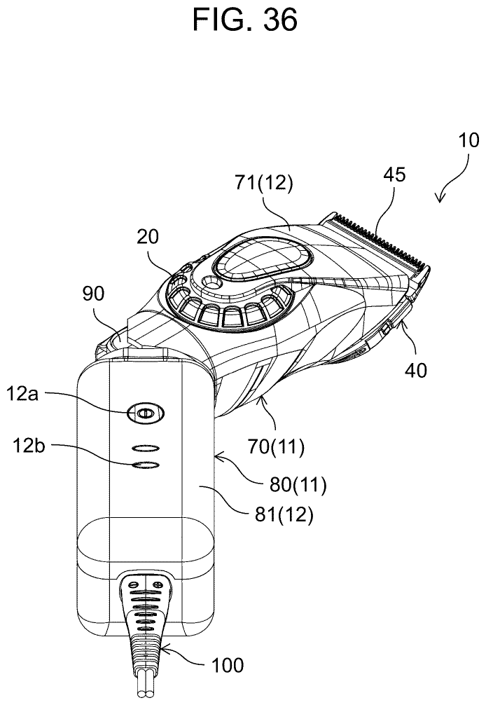

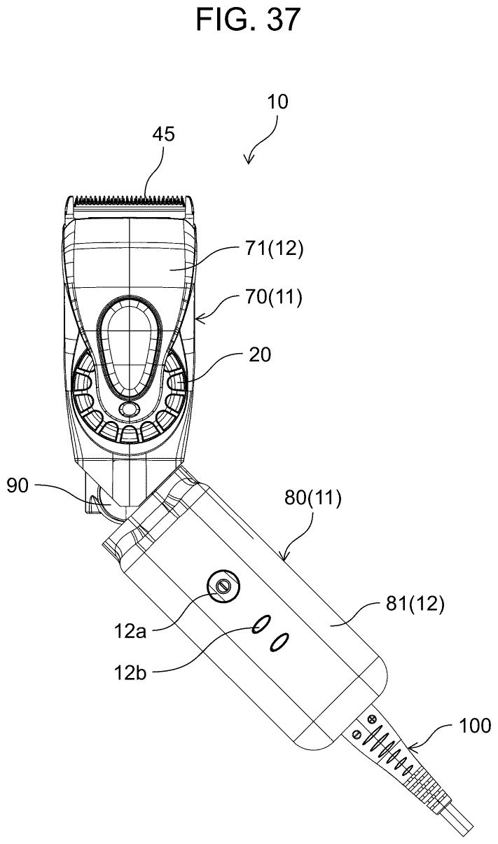

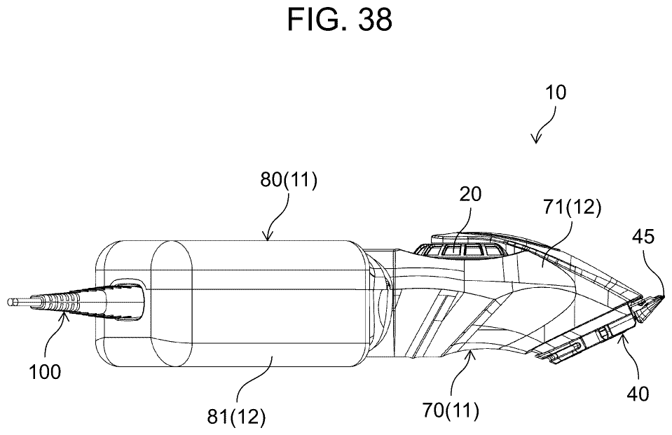

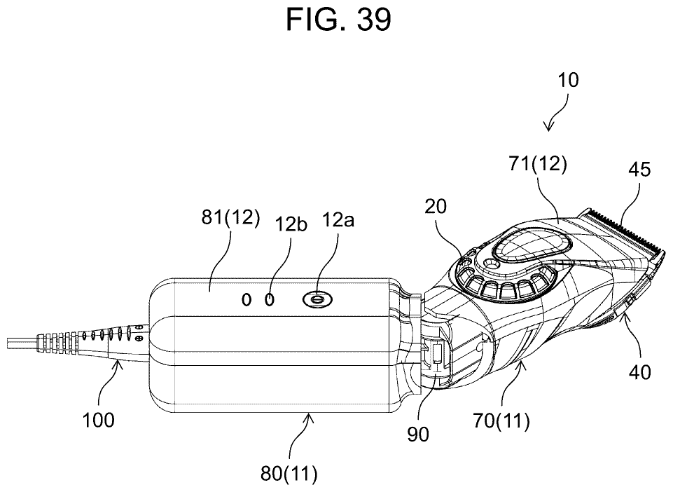

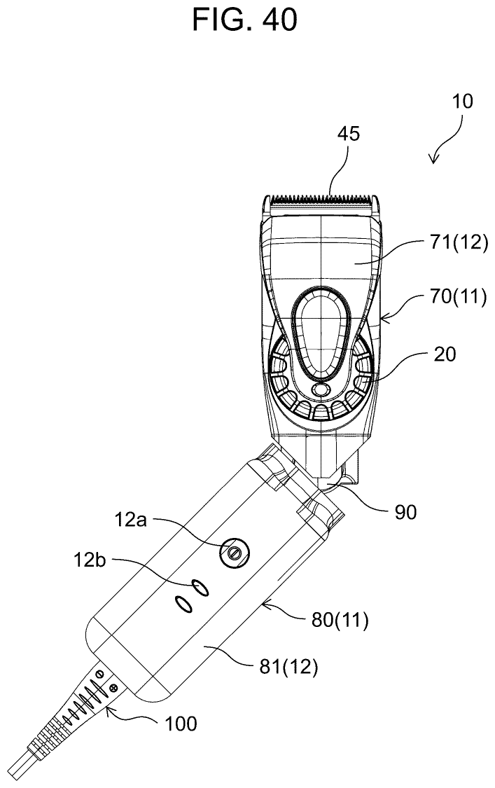

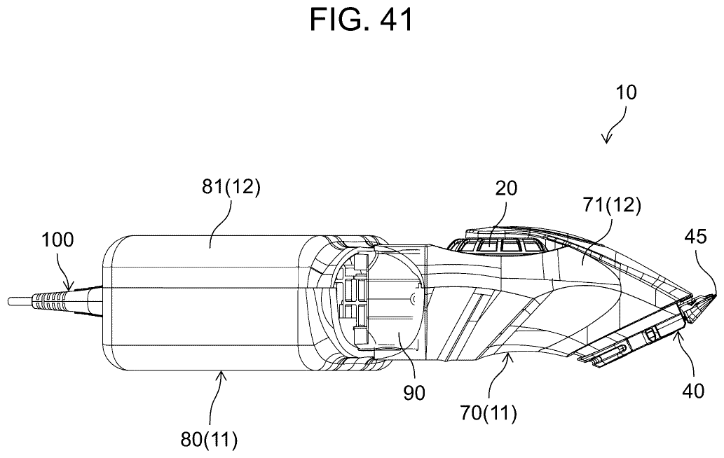

Further, the hair clipper 10 may be configured as shown in FIGS. 36 to 41. FIG. 36 is a diagram illustrating a second modification of the hair clipper 10 according to the embodiment, and is a perspective view illustrating a state in which the second main body block 60 is rotated rightward with respect to the first main body block 50. FIG. 37 is a diagram illustrating the second modification of the hair clipper 10 according to the embodiment, and is a front view illustrating the state in which the second main body block 60 is rotated rightward with respect to the first main body block 50. FIG. 38 is a right side view illustrating the second modification of the hair clipper 10 according to the embodiment in the state where the second main body block 60 is rotated rightward with respect to the first main body block 50. FIG. 39 is a diagram illustrating the second modification of the hair clipper 10 according to the embodiment, and is a perspective view illustrating a state in which the second main body block 60 is rotated leftward with respect to the first main body block 50. FIG. 40 is a diagram illustrating the second modification of the hair clipper 10 according to the embodiment, and is a front view illustrating the state where the second main body block 60 is rotated leftward with respect to the first main body block 50. FIG. 41 is a right side view showing the second modification of the hair clipper 10 according to the embodiment in the state where the second main body block 60 is rotated leftward with respect to the first main body block 50.

The hair clipper 10 shown in FIGS. 36 to 41 is also elongated in the Z direction, and includes the first main body 70 to which the blade 45 is attached on the upper side in the Z direction, and the second main body 80 connected to the lower side of the first main body 70.

The second main body portion 80 can be connected to the lower side of the first main body portion 70 in an elongated state in a direction intersecting the Z direction.

As described above, in FIGS. 36 to 41, the main body 11 includes the first main body portion 70 which is disposed in a state where the longitudinal direction substantially corresponds to the Z direction as the first direction, and the second main body portion 80 which can be disposed in a state where the longitudinal direction substantially corresponds to the Y direction as the second direction, which is a direction intersecting the Z direction.

Further, also in FIGS. 36 to 41, the second main body portion 80 may be connected to the first main body portion 70 via the coupling portion 90. That is, the second main body portion 80 can be rotated relative to the first main body portion 70.

FIGS. 36 to 41 illustrate an example in which one end of the second main body portion 80 in the longitudinal direction is connected to the lower side of the first main body portion 70 via the coupling portion 90. In addition, in the example, the second main body portion 80 can rotate leftward and rightward relative to the first main body portion 70 using the X direction as an axis.

Therefore, FIGS. 36 to 41 illustrate the hair clipper 10 in which the second main body portion 80 is connected to the first main body portion 70 in a state where the second main body portion 80 can protrude only toward one side in the second direction with respect to the first main body portion 70.

This also improves the operability of the hair clipper 10.

As described above, the hair clipper 10 shown in FIGS. 36 to 41 can also achieve substantially the same operations and effects as those of the hair clipper 10 shown in the above embodiment.

Also in the hair clippers 10 shown in FIGS. 36 to 41, the longitudinal direction of the second main body portion 80 can correspond substantially to the longitudinal direction of the first main body portion 70, and a configuration substantially similar to that of a conventional hair clipper can be selected.

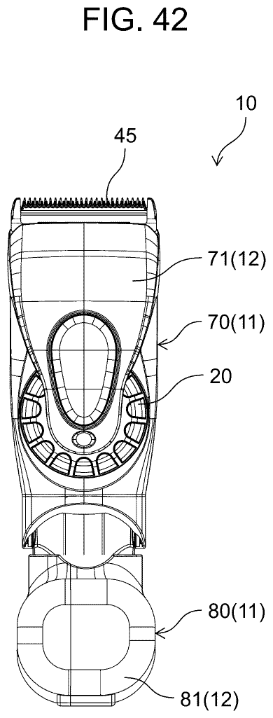

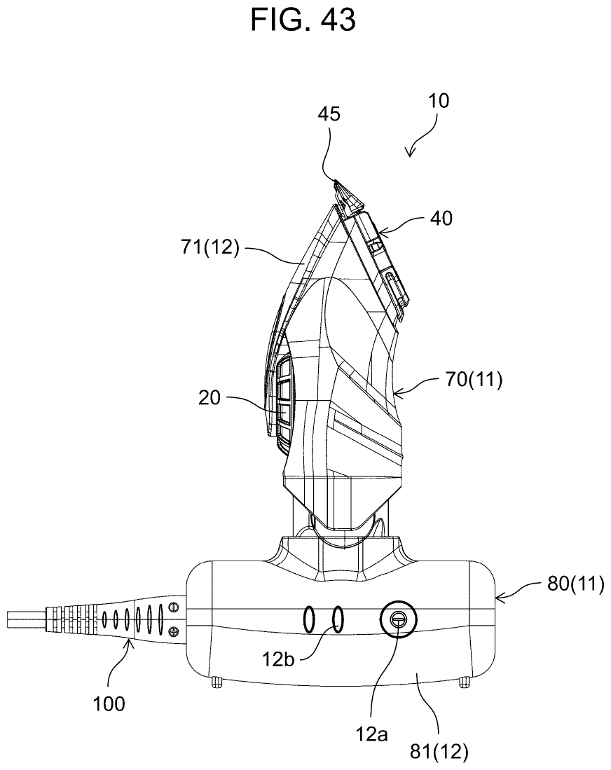

The hair clipper 10 may have a configuration shown in FIGS. 42 and 43. FIG. 42 is a front view illustrating a third modification of the hair clipper 10 according to the embodiment. FIG. 43 is a right side view illustrating the third modification of the hair clipper 10 according to the embodiment.

The hair clipper 10 shown in FIGS. 42 and 43 is also elongated in the Z direction and includes the first main body 70 to which the blade 45 is attached on the upper side in the Z direction and the second main body 80 connected to the lower side of the first main body 70.

The second main body portion 80 is connected to the lower side of the first main body portion 70 in a state of being elongated in the X direction, which is a direction intersecting the Z direction.

As described above, in FIGS. 42 and 43, the first main body portion 70 disposed in a state where the longitudinal direction thereof substantially corresponds to the Z direction as the first direction and the second main body portion 80 disposed in a state where the longitudinal direction thereof substantially corresponds to the X direction as the second direction, which is a direction intersecting the Z direction are provided.

As described above, the hair clipper 10 shown in FIGS. 42 and 43 can also achieve substantially the same operations and effects as those of the hair clipper 10 shown in the above embodiment.

Also in the hair clipper 10 shown in FIGS. 42 and 43, the second body 80 may be rotatable relative to the first main body 70.

### (Notes)

The following techniques are disclosed by the above description of the embodiments.

### (Technique 1)

A cutting device, including: a main body and a blade part attached to one end of the main body in a first direction, wherein the main body includes: a first main body portion elongated in the first direction, the blade part being attached to one end of the first main body in the first direction; and at least one of the following requirement (A) or (B) is satisfied: (A) (i) the main body comprises a second main body portion configured to be connected to the other end of the first main body portion in the first direction, (ii) the second main body portion is connected to the first main body portion via a coupling portion, and (iii) the coupling portion includes a pivot shaft configured to rotate the second main body portion relative to the first main body portion, or (B) the main body comprises a second main body portion connected to the other end of the first main body portion in the first direction in a state where the second main body portion is elongated in a second direction which intersects the first direction.

This makes it possible to intersect the longitudinal direction of the first main body portion with the longitudinal direction of the second main body portion, and to shorten the entire length of the main body portion, that is, the length in the first direction from the end portion of the main body portion, namely, the length in the first direction from one end portion of the main body to the other end portion of the main body, the one end portion being closer to the blade part than the other end portion being.

In this way, since the entire length of the main body is shortened, it is possible to prevent the tip (more specifically, the other end in the first direction) of the main body from coming into contact with the shoulder of the user, when the blade of the cutting device is brought into contact with the hair of the user from the lower side (more specifically, the neck side) and moved upward to cut the hair.

In addition, since the entire length of the main body portion is shortened, when the side portion of the first main body portion is gripped by fingers in a state in which the distal end (more specifically, the other end in the first direction) of the second main body portion faces the palm, the center of gravity of the cutting device can be positioned closer to the palm side than to the fingertips. That is, the cutting device can be held in a state where the center of gravity of the cutting device is located in the hand. This makes it possible to stably hold the cutting device in a state where the side of the main body portion opposite to the blade part is wrapped by a hand. As a result, it is possible to more reliably suppress shaking of the cutting device when the cutting device is held in such a manner that the side of the main body portion opposite to the blade part is wrapped by a hand is used.

In this manner, when the entire length of the main body portion is shortened, it is possible to provide a cutting device that is easy to use even in a state where the cutting device is held in such a manner that the side of the main body portion opposite to the blade part is wrapped by a hand. Further, when the cutting device is held in such a manner that the side of the main body portion opposite to the blade part is wrapped by a hand, the main body portion can be gripped without bending the wrist. Therefore, when the cutting device is held in such a manner that the side of the main body portion opposite to the blade part is wrapped by a hand, the hair of the user can be cut (that is, comb cut) using the comb in a state where the main body portion is held without bending the wrist. Thus, the burden on the wrist at the time of comb cut can be further reduced.

In addition, since the entire length of the main body portion is shortened, the main body portion is easily accommodated in the palm of a hand when the cutting device is held, and thus, it is possible to more reliably prevent the cutting device from being dropped during the use of the cutting device.

As described above, in the cutting device according to Technique 1, operability of the cutting device is further improved.

If the main body portion is configured by only two main body portions, that is, the first main body portion and the second main body portion, the main body portion is prevented from having a complicated shape, and can have a shape that is easier to grip.

### (Technique 2)

The cutting device according to Technique 1, wherein, as viewed in the first direction, both ends of the second main body portion protrude in the second direction from both ends of the first main body portion.

This configuration makes it possible to grip the second body portion easily by a hand, and thus the operability of the cutting device can be further improved.

### (Technique 3)

The cutting device according to Technique 1 or Technique 2, wherein a drive unit configured to drive the blade part is accommodated in the first main body portion, and a power supply unit capable of supply electric power to the drive unit is accommodated in the second main body portion.

This makes it possible to make the weight balance between the first main body portion and the second main body portion more uniform and to position the center of gravity of the main body portion at a portion closer to the central position thereof. Since the center of gravity of the main body portion is located at a portion closer to the central position thereof, the operability of the cutting device can be improved when the cutting device is gripped in various manners. Thus, the usability of the cutting device can be further improved.

### (Technique 4)

The cutting device according to any one of Technique 1 to Technique 3, wherein the blade part comprises a fixed blade and a movable blade that reciprocates with respect to the fixed blade, and a reciprocating direction of the movable blade with respect to the fixed blade is the second direction.

In this configuration, since the longitudinal direction of the second main body portion and the reciprocating direction of the movable blade are substantially parallel to each other, the blade part can be easily brought into contact with the scalp in a state where the second main body portion is gripped by a hand. Further, when the longitudinal direction of the second main body portion is substantially parallel to the reciprocating direction of the movable blade, the reciprocating direction of the movable blade can be recognized more easily.

### (Technique 5)

The cutting device according to any one of Technique 1 to Technique 4, wherein the second main body portion has a curved shape such that a surface on the other end in the first direction protrudes in a direction away from the first main body portion when a state where the second main body portion is connected to the first main body portion so as to be elongated in the second direction is viewed along a third direction intersecting the first direction and the second direction.

In this configuration, when the cutting device is held in such a manner that the side of the main body portion opposite to the blade part is gripped by a hand, a larger portion of the second main body portion on the other end in the first direction comes into contact with the palm of the hand, and thus the second main body portion can be firmly gripped by the hand. As a result, the burden on the wrist at the time of comb cutting can be further reduced.

### (Technique 6)

The cutting device according to any one of Technique 1 to Technique 5, wherein the requirement (A) is satisfied.

As above, when the second main body portion can be rotated relative to the first main body portion, it is possible to more reliably prevent the second main body portion from interfering with gripping of the first main body portion by a hand. As a result, it is possible to provide a cutting device which is adapted to various manners of gripping.

### (Technique 7)

The cutting device according to Technique 6, wherein the coupling portion includes a holding mechanism configured to hold the second body portion in a stepwise manner.

This also makes it possible to provide a cutting device which is adapted to various manners of gripping. Further, since the second main body portion can be held in a predetermined state, the second main body portion is prevented from moving relative to the first main body portion during the use of the cutting device. Thus, the usability of the cutting device can be further improved.

### (Technique 8)

The cutting device according to any one of Technique 1 to Technique 7, wherein the second main body portion includes a self-standing means for causing the main body to stand by itself in a state where the blade part is located on the upper side of the cutting device.

This allows the cutting device to stand by itself. An example of causing the main body portion to stand by itself is to dispose the cutting device in a state where the blade part is located at the upper portion thereof without using an auxiliary member such as a charging stand. In this way, since the cutting device can stand by itself, it is possible to more reliably prevent the blade part from being damaged, and it is possible to further improve the appearance of the cutting device in the placed state. In addition, since it is possible to prevent the blade part from being damaged without using an auxiliary member such as a charging stand or a member for protecting the blade part, it is possible to reduce the manufacturing cost. In addition, since the operation of placing the cutting device on the placement surface when the cutting device is not used and the operation of gripping the cutting device placed on the placement surface when the cutting device is used are facilitated, the usability of the cutting device can be further improved.

(Technique 9) The cutting device according to any one of Technique 1 to Technique 8, wherein a connector to which an external connection cord is configured to be connected is formed at a portion of the second main body portion which is an end surface in the second direction in a state where the second main body portion is connected to the first main body portion so as to be elongated in the second direction.

This makes it possible to use the cutting device while supplying external power via the external connection cord. In addition, when the external connection cord is connected to the portion of the second main body portion that becomes the end surface in the second direction, the external connection cord can be prevented as much as possible from becoming an obstacle when using the cutting device while supplying the external power via the external connection cord.

### (Technique 10)

The cutting device according to any one of Technique 1 to Technique 9, wherein a USB connector to which a USB cord is configured to be connected is formed on the second main body portion.

In this way, charging can be performed using the USB cord.

### (Technique 11)

The cutting device according to any one of Technique 1 to Technique 5, wherein the requirement (B) is satisfied.

In Technique 11, the same effect as that of Technique 1 is obtained.

### [Others]

Although the contents of the cutting device according to the present disclosure have been described above, it would be obvious to those skilled in the art that the present disclosure is not limited to these descriptions, and various modifications and improvements can be made.

For example, the present disclosure can be applied to an embodiment in which a change, replacement, addition, omission, or the like is made to the configuration illustrated in the above-described embodiment and the modification examples thereof. Further, it is also possible to provide a new embodiment by combining the constituent elements described in the above embodiment and the modifications thereof.

Further, in the above-described embodiment and the modification example thereof, the hair clipper 10 in which the second main body portion 80 can be rotated relative to the first main body portion 70 is exemplified. However, it is not necessary to rotate the second main body portion 80 relative to the first main body portion 70. The hair clipper may be configured such that the second main body portion is connected to the first main body portion in a state where relative movement is restricted.

Further, in the above-described embodiment and the modification examples thereof, the hair clipper 10 in which the second main body portion 80 can be rotated to both directions (for example, the front-rear direction and a right-left direction) in the rotation direction with respect to the first main body portion 70 is exemplified. However, the hair clipper may be configured such that the second body portion can be rotated in only one direction of the rotation direction (for example, rotated in only front direction or rotated in only left direction) with respect to the first main body part.

Alternatively, the hair clipper may be configured such that the second body 80 is detachably attached to the first main body 70.

In addition, specifications (for example, shape, size, layout, and the like) of the first main body portion, the second body portion, and other details can be appropriately changed.

### INDUSTRIAL APPLICABILITY

As described above, since the cutting device according to the present disclosure can further improve operability, the cutting device can be applied to a hair clipper that cuts human hair, a pet hair clipper that cuts pet hair, and the like.

### REFERENCE SIGNS LIST

10 hair clipper
11 main body
12 housing
12a switch portion
12b display
20 cutting height adjustment mechanism
21 dial
211 rotation shaft
22 transmission mechanism
221 first conversion mechanism
2211 coupling lever
22111 rod
22112 pin
22113 slider
22114 hook portion
2212 coil spring
222 second conversion mechanism
2221 operation axis
2222 rotating member
23 holding mechanism
231 holding spring
40 blade block
41 Fixing plate
41a hook portion
42 guide plate
43 push-up spring
44 switching lever
45 blade part
46 movable blade
461 movable blade bar
47 fixed blade
471 fixing blade bar
50 first main body block
60 second main body block
70 first main body portion
71 first housing
711 first front-side housing
7111 fixing portion
712 first rear-side housing
7121 partition wall
71211 through hole
713 blade base
714 cover
7141 cover body
7142 finger rest
72 linear motor
73 drive shaft
74 blade stop spring
75 dustproof cover
80 second main body portion
801 front face
802 rear surface
8021 USB connector
803 side surface
8031 connector
804 upper surface
805 lower surface
8051 curved surface
806 rib
81 second housing
811 second front housing
8111 through hole
8112 through hole
812 second rear housing
8121 holding wall
82 switch button
83 cover member
831 lamp cover portion
832 switch button holding portion
84 circuit block
841 rechargeable battery
842 Control board
8421 battery holding base
90 coupling portion
91 fixing member
911 through hole
912 ball holding position
92 pivot shaft
93 shaft cap
94 rotating member
941 accommodating wall
942 rotating portion
9421 through hole
9422 insertion hole
95 holding mechanism
951 ball
952 ball receiver
9521 ball receiving hole
9522 holding piece
100 AC code
110 USB code
120 placement part
121 placement surface
F1 thumb
F2 index finger
F3 middle finger
F4 ring finger
F5 little finger
G center of gravity
H hair
H1 hand
H11 palm
U User

1. A cutting device, comprising:
a main body; and
a blade part attached to one end of the main body in a first direction,
wherein
the main body comprises a first main body portion elongated in the first direction, the blade part being attached to one end of the first main body in the first direction, and
at least one of the following requirement (A) or (B) is satisfied:
(A) (i) the main body comprises a second main body portion configured to be connected to the other end of the first main body portion in the first direction;
(ii) the second main body portion is connected to the first main body portion via a coupling portion; and
(iii) the coupling portion includes a pivot shaft configured to rotate the second main body portion relative to the first main body portion; or
(B) the main body comprises a second main body portion connected to the other end of the first main body portion in the first direction in a state where the second main body portion is elongated in a second direction which intersects the first direction.

2. The cutting device according to claim 1, wherein
As viewed in the first direction, both ends of the second main body portion protrude in the second direction from both ends of the first main body portion.

3. The cutting device according to claim 1, wherein
a drive unit configured to drive the blade part is accommodated in the first main body portion, and
a power supply unit capable of supply electric power to the drive unit is accommodated in the second main body portion.

4. The cutting device according to claim 1, wherein
the blade part comprises a fixed blade and a movable blade that reciprocates with respect to the fixed blade, and
a reciprocating direction of the movable blade with respect to the fixed blade is the second direction.

5. The cutting device according to claim 1, wherein
the second main body portion has a curved shape such that a surface on the other end in the first direction protrudes in a direction away from the first main body portion when a state where the second main body portion is connected to the first main body portion so as to be elongated in the second direction is viewed along a third direction intersecting the first direction and the second direction.

6. The cutting device according to claim 1, wherein
the requirement (A) is satisfied.

7. The cutting device according to claim 6, wherein
the coupling portion includes a holding mechanism configured to hold the second body portion in a stepwise manner.

8. The cutting device according to claim 1, wherein
the second main body portion includes a self-standing means for causing the main body to stand by itself in a state where the blade part is located on an upper side of the cutting device.

9. The cutting device according to claim 1, wherein
a connector to which an external connection cord is configured to be connected is formed at a portion of the second main body portion which is an end surface in the second direction in a state where the second main body portion is connected to the first main body portion so as to be elongated in the second direction.

10. The cutting device according to claim 1, wherein
a USB connector to which a USB cord is configured to be connected is formed on the second main body portion.

11. The cutting device according to claim 1, wherein
the requirement (B) is satisfied.
